(19) United States
(12) Patent Application Publication
(10) Pub. No.: US 2026/0284530 A1
(43) Pub. Date: Sep. 24, 2026

(54) SYSTEM, NON-TRANSITORY COMPUTER-READABLE STORAGE MEDIUM, AND METHOD

(71) Applicant: NINTENDO CO., LTD., Kyoto-shi (JP)

(72) Inventors: Takafumi AOKI, Kyoto-shi (JP); Shiro KATO, Kyoto-shi (JP); Yuma IWAI, Kyoto-shi (JP)

(21) Appl. No.: 19/567,839

(22) Filed: Mar. 16, 2026

(30) Foreign Application Priority Data
Mar. 19, 2025 (JP) 2025-045397

(51) Int. Cl. A63F 13/53; A63F 13/285; A63F 13/803; G06F 3/01

(52) U.S. Cl. CPC A63F 13/53; A63F 13/285; A63F 13/803; G06F 3/016; A63F 2300/638

(57) ABSTRACT

An information processing system controls drive of a vibration motor in accordance with vibration instructions from an application program, determines restriction under a first condition and restriction under a second condition, restricts vibration of the vibration motor when at least one of the first condition or the second condition is satisfied, and notifies a user of restriction of vibration of the vibration motor in a manner different between when the first condition is satisfied and when the second condition is satisfied.

This non-provisional application is based on Japanese Patent Application No. 2025-045397 filed with the Japan Patent Office on Mar. 19, 2025, the entire contents of which are hereby incorporated by reference.

### FIELD

The present disclosure relates to an information processing system, a program, and a method.

### BACKGROUND AND SUMMARY

An information processing system that applies vibration to a user has been known. For example, a vibration signal generation program that changes a vibration parameter has been known.

There is a room for improvement in method for notifying a user of a control state of a vibration motor.

(Configuration 1) An exemplary embodiment provides an information processing system that includes one or more processors and one or more memories having stored therein instructions that, when executed, cause the one or more processors to perform operations. The operations include controlling drive of a vibration motor in accordance with vibration instructions from an application program, determining whether a first condition is satisfied and whether a second condition is satisfied, restricting vibration of the vibration motor when at least one of the first condition or the second condition is satisfied, and providing a user with a notification of restriction of vibration of the vibration motor in a manner different between when the first condition is satisfied and when the second condition is satisfied.

According to this configuration, the user can be informed of the fact that the vibration motor is not temporarily vibrating.

(Configuration 2) In Configuration 1, the first condition may include a condition about a temperature and the second condition may include a condition about a remaining battery level.

(Configuration 3) In Configuration 1 or 2, the notification may be provided when change from a state in which the first condition or the second condition is not satisfied to a state in which the first condition or the second condition is satisfied. According to this configuration, a frequency of notification can be appropriate.

(Configuration 4) In Configuration 1 or 2, the notification may be provided when change from a state in which the first condition or the second condition is not satisfied to a state in which the first condition or the second condition is satisfied. For the second condition, a second threshold value for determining that the second condition is not satisfied may be higher than a first threshold value for determining that the second condition is satisfied. According to this configuration, a higher frequency of notification at a boundary between conditions can be prevented.

(Configuration 5) In any of Configurations 1 to 4, when the first condition is satisfied, vibration of the vibration motor may be restricted for a predetermined time period.

(Configuration 6) In any of Configurations 1 to 5, the notification may be provided when the vibration instructions are provided from the application program after at least one of the first condition or the second condition is satisfied. According to this configuration, timing or the frequency of notification can be appropriate.

(Configuration 7) In any of Configurations 1 to 6, the notification may be showing the notification including an image generated by the application program. According to this configuration, a player who is playing a game can immediately know a vibration stop state.

(Configuration 8) In any of Configurations 1 to 7, the notification does not have to further be provided even when the application program provides further vibration instructions while restriction of vibration of the vibration motor continues.

(Configuration 9) In any of Configurations 1 to 8, after restriction of vibration of the vibration motor is released, when at least one of the first condition or the second condition is satisfied and vibration of the vibration motor is restricted again and then when the application program provides the vibration instructions, the notification may be provided.

(Configuration 10) In any of Configurations 1 to 9, the information processing system may include a main device and a controller including the vibration motor. The controller may make the determination as to whether the first condition is satisfied and whether the second condition is satisfied. The controller may periodically transmit a result of the determination to the main device. The main device may provide the notification based on at least one of change from a state in which the first condition is not satisfied to a state in which the first condition is satisfied or change from a state in which the second condition is not satisfied to a state in which the second condition is satisfied, based on the result of the determination.

(Configuration 11) In any of Configurations 1 to 10, the information processing system may include a main device and a plurality of controllers each including the vibration motor. Each of the plurality of controllers may make the determination as to whether the first condition is satisfied and whether the second condition is satisfied. Each of the plurality of controllers may be restricted based on a corresponding result of the determination. The main device may determine whether the notification is required for each controller, based on the result of the determination from each of the plurality of controllers. The notification may include identification information of a controller where vibration is restricted.

(Configuration 12) In any of Configurations 1 to 11, the information processing system may include a plurality of controllers each including the vibration motor. The determination as to whether the first condition is satisfied and whether the second condition is satisfied may be made for each of the plurality of controllers. Each of the plurality of controllers may be restricted based on a corresponding result of the determination. The vibration instructions from the application program may include identification information that designates a controller which is an output destination among the controllers. The notification may be provided when the application program provides the vibration instructions, with a controller where vibration is restricted being designated among the controllers. The notification may include identification information of the controller where vibration is restricted.

(Configuration 13) An exemplary embodiment provides computer-executable instructions that cause one or more computers to implement an information processing system.

(Configuration 14) An exemplary embodiment provides a computer-implemented method that includes driving a vibration motor in accordance with vibration instructions from an application program, making determination as to whether a first condition is satisfied and whether a second condition is satisfied, restricting vibration of the vibration motor when at least one of the first condition or the second condition is satisfied, and providing a user with a notification of restriction of vibration of the vibration motor, together with a reason based on the determination.

In any configuration above, a single processor does not have to perform all processing, and a plurality of processors may perform the processing in a distributed manner. When a plurality of processors are adopted, the processors may be located in an identical apparatus or in different apparatuses.

In any configuration above, necessary processing may be performed by execution of a single program, or by execution of different programs by a plurality of processors.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an exemplary illustrative non-limiting drawing illustrating an exemplary configuration of a game system according to the present embodiment.

FIG. 2 shows an exemplary illustrative non-limiting drawing for illustrating processing for generating a time-series vibration instruction data group in a main device according to the present embodiment.

FIG. 3 shows an exemplary illustrative non-limiting drawing illustrating exemplary frequency characteristics of a maximum allowable voltage in the game system according to the present embodiment.

FIG. 4 shows an exemplary illustrative non-limiting flowchart illustrating exemplary processing by a game program in the main device according to the present embodiment.

FIG. 5 shows an exemplary illustrative non-limiting flowchart illustrating exemplary processing by a system program in the main device according to the present embodiment.

FIG. 6 shows an exemplary illustrative non-limiting flowchart illustrating exemplary processing for generating control data in a controller according to the present embodiment.

FIG. 7 shows an exemplary illustrative non-limiting flowchart illustrating a modification of the processing for generating control data in the controller according to the present embodiment.

FIG. 8 shows an exemplary illustrative non-limiting flowchart illustrating processing for obtaining a resistance value for temperature estimation in the controller according to the present embodiment.

FIG. 9 shows an exemplary illustrative non-limiting flowchart illustrating exemplary further detailed processing in processing for determining an order of an LPF shown in FIG. 8.

FIG. 10 shows an exemplary illustrative non-limiting flowchart illustrating temperature estimation processing and vibration instruction data correction processing in the controller according to the present embodiment.

FIG. 11 shows an exemplary illustrative non-limiting flowchart illustrating temperature measurement processing and vibration restriction processing in the controller according to the present embodiment.

FIG. 12 shows an exemplary illustrative non-limiting flowchart illustrating remaining battery level measurement processing and vibration instruction data correction processing in the controller according to the present embodiment.

FIG. 13 shows an exemplary illustrative non-limiting flowchart illustrating exemplary processing for transmitting a restriction state in the controller according to the present embodiment.

FIG. 14 shows an exemplary illustrative non-limiting flowchart illustrating exemplary processing for updating a notification flag in the main device according to the present embodiment.

FIG. 15 shows an exemplary illustrative non-limiting flowchart illustrating exemplary processing in notification processing shown in FIG. 5.

FIGS. 16A to 16C show exemplary illustrative non-limiting drawings illustrating exemplary representation in the notification processing shown in FIG. 5.

### DETAILED DESCRIPTION OF NON-LIMITING EXAMPLE EMBODIMENTS

The present embodiment will be described in detail with reference to the drawings. The same or corresponding elements in the drawings have the same reference characters allotted and description thereof will not be repeated.

The term “measurement” herein encompasses “estimation”. The term “estimation” can also be read as “measurement” in the description below.

### [A. Exemplary System Configuration]

An exemplary configuration of a game system 10 according to the present embodiment will initially be described by way of example of an information processing system.

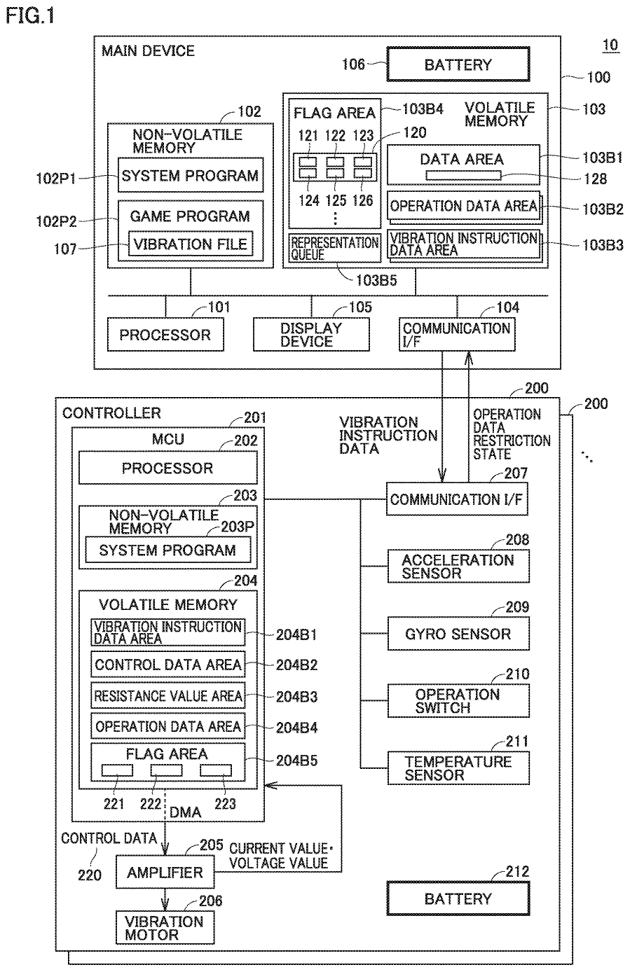

Referring to FIG. 1, game system 10 includes a main device 100 and one or more controllers 200. Main device 100 executes an application program such as a game program.

Each of controllers 200 receives an operation from a user and transmits operation data showing contents of the received operation to main device 100. Each of controllers 200 includes a vibration motor 206, and has vibration motor 206 driven in accordance with instructions from main device 100. For example, each of controllers 200 has vibration motor 206 driven in accordance with vibration instructions from an application program executed in main device 100.

Though FIG. 1 shows an exemplary configuration in which game system 10 includes a plurality of controllers 200, game system 10 may include only a single controller 200.

Main device 100 includes a processor 101, a non-volatile memory 102, a volatile memory 103, and a communication interface (I/F) 104, a display device 105, and a battery 106.

Processor 101 is a processing entity that performs processing in main device 100. Processor 101 is processing circuitry, and it is implemented, for example, by a central processing unit (CPU) and a graphics processing unit (GPU). Processor 101 develops a program stored in non-volatile memory 102 on volatile memory 103 to execute the same. Processor 101 may be implemented by a system on chip (SoC) in which functions of the CPU and the GPU are integrated.

The term “processor” herein encompasses at least processing circuitry that performs processing in accordance with computer-executable instructions, such as a CPU and a GPU, an SoC in which a plurality of functions are integrated, and hard-wired circuitry such as an application specific integrated circuit (ASIC) and a field programmable gate array (FPGA).

Non-volatile memory 102 is a storage medium accessible by processor 101, and it is implemented, for example, by a flash memory, a read only memory (ROM), a solid state drive (SSD), and the like. Non-volatile memory 102 may be, for example, a storage medium attachable to and removable from main device 100, such as an optical disc and a cartridge.

For example, a system program 102P1 and a game program 102P2 are stored in non-volatile memory 102.

System program 102P1 includes computer-executable instructions for performing basic processing such as processing for communication between main device 100 and one or more controllers 200. System program 102P1 may include a library necessary for execution of game program 102P2.

Game program 102P2 includes computer-executable instructions for performing game processing. Game program 102P2 includes, for example, a vibration file 107.

Processing in main device 100 which will be described later may be performed by execution of at least one of system program 102P1 or game program 102P2 by processor 101.

Volatile memory 103 is a storage medium accessible by processor 101, and it is implemented, for example, by a dynamic random access memory (DRAM) or the like. While the game processing is being performed, volatile memory 103 includes a data area 103B1 for proceeding of a game, an operation data area 103B2, a vibration instruction data area 103B3, a flag area 103B4, and a representation queue 103B5.

Data area 103B1 is an area where data necessary for proceeding of the game is to temporarily be stored. Processor 101 refers to data area 103B1 while game program 102P2 is running and updates data in data area 103B1. For example, controller information 128 may be stored in data area 103B1. Controller information 128 may include identification information or model information of one or more controllers 200 connected to main device 100 and correspondence between each controller 200 and a player number (for example, an identification number of a game object in game processing that is being performed).

Operation data area 103B2 is an area where operation data transmitted from each of controllers 200 is to temporarily be stored. Operation data area 103B2 may be prepared for each controller 200 or a single operation data area 103B2 may be divided for controllers 200. Processor 101 refers to operation data area 103B2 while game program 102P2 is running.

Vibration instruction data area 103B3 is an area where vibration instruction data for vibration of vibration motor 206 of each controller 200 is to temporarily be stored. Vibration instruction data area 103B3 may be prepared for each controller 200 or a single vibration instruction data area 103B3 may be divided for controllers 200.

Processor 101 writes, for each controller 200, vibration instruction data into vibration instruction data area 103B3 in predetermined cycles (for example, 60 frames per second (fps); approximately 16-msec. cycle) as game program 102P2 runs. Controllers 200 may be different from one another in cycle of writing of the vibration instruction data. Details of the vibration instruction data will be described later.

Flag area 103B4 is an area where one or more flags to be used in notification processing which will be described later are to be stored. For example, a flag set 120 prepared for each controller 200 is stored in flag area 103B4. Each of flag sets 120 includes, for example, an internal temperature restriction flag 121, a temperature sensor restriction flag 122, a remaining battery level restriction flag 123, an internal temperature notification flag 124, a temperature sensor notification flag 125, and a remaining battery level notification flag 126 for each controller 200. Flag area 103B4 may be prepared for each controller 200.

Internal temperature restriction flag 121, temperature sensor restriction flag 122, and remaining battery level restriction flag 123 indicate restriction states transmitted from corresponding controller 200, respectively. Internal temperature restriction flag 121, temperature sensor restriction flag 122, and remaining battery level restriction flag 123 are also collectively referred to as a “restriction flag.”

Internal temperature notification flag 124, temperature sensor notification flag 125, and remaining battery level notification flag 126 indicate notification states in main device 100, respectively. Internal temperature notification flag 124, temperature sensor notification flag 125, and remaining battery level notification flag 126 are also collectively referred to as a “notification flag.” Details of processing using flag set 120 will be described later.

Though the term “flag” is used for the sake of convenience of description, any data format is applicable so long as a state can be indicated. For example, a bit string of one or more digits may be employed.

Representation queue 103B5 is an area for queuing data for overlaid representation or the like. Overlaid representation may be used as exemplary notification processing which will be described later.

The term “memory” herein encompasses at least non-volatile memory 102 and volatile memory 103.

Communication interface 104 communicates data with controller 200 through at least one of wireless communication or wired communication. In wireless communication, communication interface 104 includes, for example, a wireless chip in conformity with Bluetooth® standards. In wired communication, communication interface 104 includes, for example, a wired communication controller in conformity with communication standards of universal serial bus (USB).

Display device 105 shows video images, an image, or the like generated by execution of an application program. Display device 105 may include a display or may be an interface with a not-shown external display.

Battery 106 supplies electric power necessary in main device 100 including the vibration motor. Main device 100 includes a circuit for supply of electric power to each component in main device 100 by battery 106 and a circuit for charging of battery 106 with an external power supply (neither of which is shown). Main device 100 may include a circuit that measures a remaining battery level of battery 106.

Controller 200 includes a micro controller unit (MCU) 201 which is exemplary processing circuitry, an amplifier 205, vibration motor 206, a communication interface (I/F) 207, an acceleration sensor 208, a gyro sensor 209, an operation switch 210, a temperature sensor 211, and a battery 212.

Controller 200 is typically held with both hands or one hand of the user and receives an operation by the user as a result of operation on operation switch 210 with a user's finger. Controller 200 is not limited to a controller in such a form as being held by the user. For example, a general-purpose keyboard and/or mouse including vibration motor 206 may be applicable, or the controller may be laid on a floor and receive input based on touch of a sole of the user.

MCU 201 includes a processor 202, a non-volatile memory 203, and a volatile memory 204.

Processor 202 is a processing entity that performs processing in controller 200. Processor 202 develops a program stored in non-volatile memory 203 on volatile memory 204 to execute the same. Since processor 202 is similar in hardware configuration to processor 101 described above, detailed description will not be repeated.

For example, a system program 203P is stored in non-volatile memory 203. Since non-volatile memory 203 is similar in hardware configuration to non-volatile memory 102 described above, detailed description will not be repeated.

Volatile memory 204 includes a vibration instruction data area 204B1, a control data area 204B2, a resistance value area 204B3, an operation data area 204B4, and a flag area 204B5 while processing in controller 200 is being performed. Since volatile memory 204 is similar in hardware configuration to volatile memory 103 described above, detailed description will not be repeated.

Vibration instruction data area 204B1 is an area (first-in first-out (FIFO) buffer) where the vibration instruction data transmitted from main device 100 is to temporarily be stored.

Control data area 204B2 is an area (an FIFO buffer) where the control data for vibration of vibration motor 206 generated by processor 202 is to temporarily be stored. As will be described later, in the present embodiment, the control data is generated based on the vibration instruction data.

Resistance value area 204B3 is an area where a resistance value calculated based on values of a current and a voltage supplied by amplifier 205 to vibration motor 206 is to temporarily be stored.

Operation data area 204B4 is an area where detection values from acceleration sensor 208, gyro sensor 209, operation switch 210, and the like are to temporarily be stored. Operation data is generated based on data stored in operation data area 204B4.

Flag area 204B5 is an area where one or more flags to be used for management of a restriction state are to be stored. For example, an internal temperature restriction flag 221, a temperature sensor restriction flag 222, and a remaining battery level restriction flag 223 are stored in flag area 204B5.

Though FIG. 1 shows an exemplary configuration in which MCU 201 including processor 202, non-volatile memory 203, and volatile memory 204 is employed, a configuration in which each element is independent may be adopted.

Amplifier 205 supplies electric power to vibration motor 206 in accordance with control data 220. Amplifier 205 may supply a pulse width modulation (PWM) signal at a predetermined carrier frequency (for example, 8 kHz) to vibration motor 206. Amplifier 205 determines a duty ratio based on control data 220 and generates the PWM signal every operation cycle (1.8 kHz=0.125 ms) corresponding to one carrier. Control data 220 stored in control data area 204B2 in volatile memory 204 is written in amplifier 205, for example, in predetermined cycles by direct memory access (DMA).

Vibration motor 206 is, for example, an eccentric motor where a weight eccentric in shape is attached to a rotation shaft. As vibration motor 206 rotates, vibration is generated. Vibration motor 206 may be a linear motor, a coin vibration motor, or the like. Vibration motor 206 can thus apply vibration to the user who holds controller 200 where vibration motor 206 is accommodated. Vibration motor 206 may be, for example, a voice coil motor capable of outputting audible sound.

Communication interface 207 communicates data with main device 100 through at least one of wireless communication or wired communication. Since communication interface 207 is similar in hardware configuration to communication interface 104 described above, detailed description will not be repeated. A cycle of communication between communication interface 104 and communication interface 207 may be variable based on a command or the like from at least one of processor 101 or processor 202.

Acceleration sensor 208 detects magnitude of a linear acceleration along directions along predetermined three axes. Acceleration sensor 208 may detect an acceleration in a direction along one axis or directions along two axes.

Gyro sensor 209 detects an inclination, an angular velocity, an angular acceleration, and the like of controller 200.

Operation switch 210 is implemented by at least one button, key, or stick provided at a surface of controller 200. Operation switch 210 may typically be implemented by a button brought in correspondence with a character such as an A button and a B button, a cross-shaped key for input of upward, downward, left, and right directions, a 3D stick for input of a direction of inclination and an amount of inclination, or the like.

Temperature sensor 211 is a sensor that measures an internal temperature of controller 200. Temperature sensor 211 is implemented, for example, by a thermistor. Temperature sensor 211 may be arranged in the vicinity of vibration motor 206. When temperature sensor 211 is arranged at a location which is also the vicinity of MCU 201, it can sense increase in temperature of both of vibration motor 206 and MCU 201.

Battery 212 supplies electric power necessary in controller 200. Controller 200 includes a circuit for supply of electric power to each component in controller 200 by battery 212 and a circuit for charging of battery 212 with an external power supply (neither of which is shown). Controller 200 may include a circuit that measures a remaining battery level of battery 212. The circuit that measures the remaining battery level may include, for example, at least one of a circuit that measures a voltage value of battery 212 or a circuit that measures a value of a current that flows in battery 212.

A not-shown one or more peripheral devices may be connectable to controller 200. In this case, controller 200 may include an interface for connection to the peripheral device.

System program 203P includes computer-executable instructions for performing processing necessary in controller 200. System program 203P includes computer-executable instructions for performing in parallel, a plurality of types of processing such as (1) processing to generate control data 220 to be provided to amplifier 205 based on the vibration instruction data received from main device 100, (2) processing to estimate a temperature of vibration motor 206, (3) processing to restrict vibration of vibration motor 206 based on the estimated temperature, (4) processing to change the frequency of vibration of vibration motor 206 based on the estimated temperature, (5) processing to restrict vibration of vibration motor 206 based on the temperature measured by temperature sensor 211, (6) processing to change the frequency of vibration motor 206 based on the temperature measured by temperature sensor 211, (7) processing to filter detection values from acceleration sensor 208 and gyro sensor 209, (8) processing to calculate a posture based on the detection values from acceleration sensor 208 and gyro sensor 209, and (9) processing to communicate between controller 200 and main device 100. At least one or all of the processing (1) to the processing (9) may be computer-executable instructions independent of one another. In other words, system program 203P may be an assembly of software prepared for each type of processing.

Processing for communication between main device 100 and controller 200 includes processing for transmitting operation data including detection values from acceleration sensor 208, gyro sensor 209, operation switch 210, and the like to main device 100, processing for transmitting a restriction state, and processing for receiving the vibration instruction data from main device 100.

### [B. Vibration Instruction Data]

The vibration instruction data transmitted from main device 100 to controller 200 will now be described.

The vibration instruction data is data that indicates a vibration effect. The vibration instruction data is used for control of vibration motor 206. The vibration instruction data designates, for example, a waveform of the control data for control of vibration at certain timing. Vibration instruction data 116 may include at least one vibration parameter that indicates the waveform of the control data. Vibration instruction data 116 may include a set of an amplitude parameter and a frequency parameter by way of example of a vibration parameter. The amplitude parameter is an exemplary instruction for an amplitude value of vibration and the frequency parameter is an exemplary instruction for a frequency of vibration.

In the present embodiment, the vibration effect for a period of T×N (msec.) is designated by designation of at least one (N) piece of vibration instruction data 116 every vibration instruction cycle T (msec.) in a chronological order. N pieces of vibration instruction data 116 designated in the chronological order will also be referred to as a “time-series vibration instruction data group” below. For example, a vibration instruction cycle T may be set to T=5 msec.

By adopting such a data format, the vibration effect that varies in amplitude value and frequency can readily be designated.

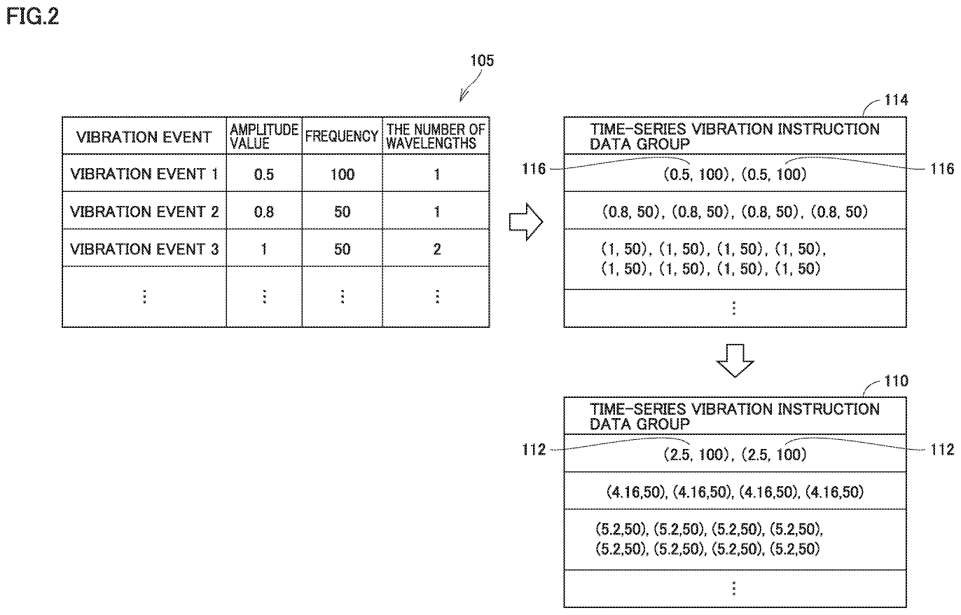

Referring to FIG. 2, exemplary processing for generating a time-series vibration instruction data group 110 will be described. Vibration file 107 includes information for indicating the vibration effect for each vibration event.

More specifically, in vibration file 107, a wavelength number parameter in addition to the vibration parameter (the amplitude parameter and the frequency parameter) is set for each vibration event. The wavelength number parameter is used for determining the number of vibration parameters to be included in a time-series vibration parameter group.

For example, in a vibration event 1, the frequency is set to “100 Hz” and the wavelength number parameter is set to “1”. Therefore, the vibration effect corresponding to the vibration event 1 lasts for a period of 10 msec, which is comparable to one wavelength of 100 Hz. Consequently, time-series vibration instruction data group 110 that indicates the vibration effect corresponding to the vibration event 1 includes two pieces of vibration instruction data. In other words, time-series vibration instruction data group 110 includes the vibration instruction data over two vibration instruction cycles.

In vibration file 107 shown in FIG. 2, the amplitude parameter in the amplitude instruction data is normalized to 0 to 1. As a result of execution of game program 102P2, vibration instruction data 116 (a time-series vibration instruction data group 114) including the normalized amplitude parameter is generated. As a result of execution of system program 102P1, the amplitude parameter in vibration instruction data 116 is multiplied by a maximum allowable voltage in accordance with the frequency, so that vibration instruction data 112 is generated. The amplitude parameter in vibration instruction data 112 indicates a voltage amplitude value. Generated vibration instruction data 112 (time-series vibration instruction data group 110) is written in vibration instruction data area 103B3 (see FIG. 1).

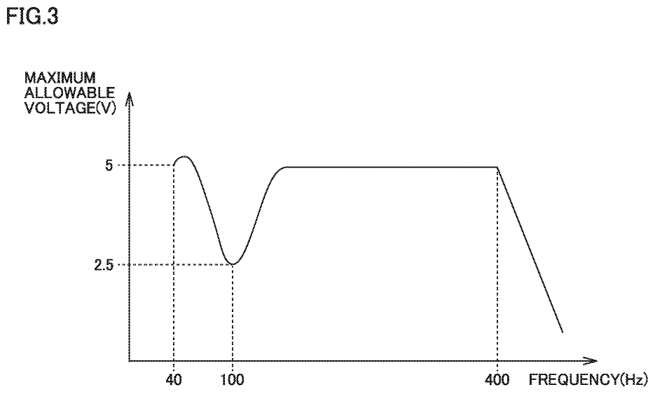

Referring to FIG. 3, exemplary frequency characteristics of the maximum allowable voltage will be described. A maximum voltage (which will also be referred to as the “maximum allowable voltage” below) applicable to vibration motor 206 is different for each frequency. System program 102P1 can refer to the frequency characteristics of the maximum allowable voltage as shown in FIG. 3.

According to such a configuration, the maximum allowable voltage can conveniently be used for each frequency to also increase an amount of vibration of vibration motor 206. Since time-series vibration instruction data group 110 can be generated without consideration of specifications or the like of vibration motor 206, implementation of game program 102P2 can be facilitated.

Though exemplary processing in which time-series vibration instruction data group 110 (one or more pieces of vibration instruction data 112) is generated each time based on vibration file 107 is shown in the description above, time-series vibration instruction data group 110 may be prepared in advance as data in a file format. In this case, processor 101 may read the data each time, while game program 102P2 is running. Since the necessity for processing for generating time-series vibration instruction data group 110 each time is obviated by using such data in the file format, implementation of game program 102P2 can be facilitated. Vibration instruction data 112 may be generated in real time without using vibration file 107.

Though exemplary processing using the vibration instruction data that designates vibration at certain timing is shown in the description above, variation instruction data that designates variation from immediately preceding vibration may be adopted. The variation instruction data shows an amount of change in amplitude value and frequency, for example, as compared to the vibration parameter in an immediately preceding vibration instruction cycle. In this case, the vibration parameter in the present vibration instruction cycle is calculated based on the vibration parameter in the immediately preceding vibration instruction cycle and the amount of change in amplitude value and frequency. Though such processing for calculating the vibration parameter may be performed by processor 101 of main device 100, the entirety or a part of the processing may be performed by MCU 201 of controller 200.

Though exemplary processing in which vibration instruction data 116 including the normalized amplitude parameter is generated by execution of game program 102P2 by processor 101 is shown in the description above, vibration instruction data 112 including the amplitude parameter that indicates the voltage amplitude value may directly be generated by execution of game program 102P2.

When time-series vibration instruction data group 110 is stored in vibration instruction data area 103B3, a predetermined number of pieces of vibration instruction data 112 are sequentially transmitted from main device 100 to controller 200 every cycle (for example, 5 msec.) of communication between communication interface 104 and communication interface 207.

[C. Exemplary Processing in Main Device 100] Exemplary processing in main device 100 will now be described.

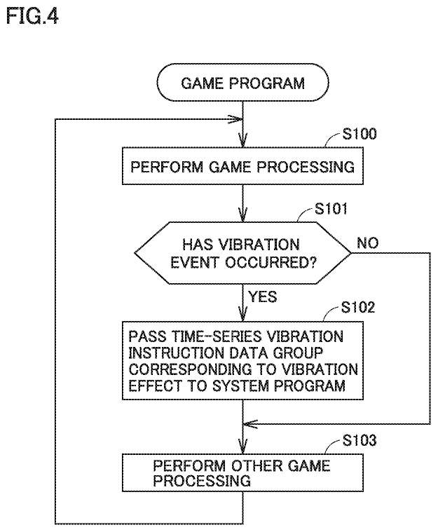

Exemplary processing by game program 102P2 in main device 100 according to the present embodiment will be described with reference to FIG. 4. Each step shown in FIG. 4 is performed, for example, by execution of game program 102P2 by processor 101 of main device 100. Though game program 102P2 may be, for example, an action game, the type of the game is not limited.

Processor 101 performs game processing (step S100). The game processing includes processing for determining a status of a game character based on operation data, processing for generating an image to be outputted to a display apparatus, or the like.

Processor 101 determines whether or not the vibration event has occurred as the game processing is performed (step S101). The vibration event is a trigger for application of vibration to the user, and it is, for example, an event such as collision of a game object against another game object or explosion in a virtual space. The vibration event may be an event that occurs at predetermined timing. The vibration event may occur when a predetermined condition is satisfied as the game proceeds.

When the vibration event has occurred (YES in step S101), processor 101 passes time-series vibration instruction data group 114 corresponding to the vibration effect to system program 102P1 (step S102). When the vibration event has not occurred (NO in step S101), processing in step S102 is skipped.

Processor 101 performs other game processing (step S103). Processing in steps S100 to S103 is repeated until a condition for quitting the game processing is satisfied.

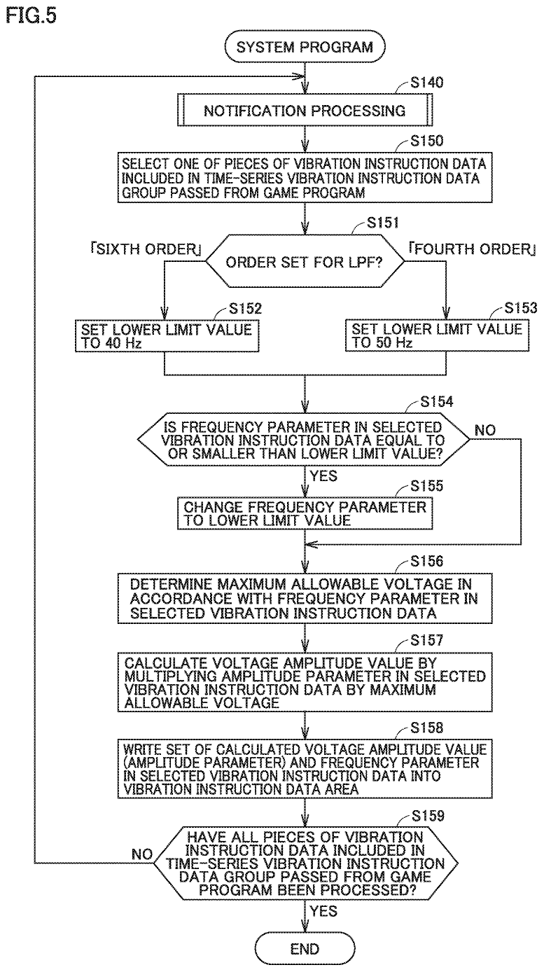

Exemplary processing by system program 102P1 in main device 100 will be described with reference to FIG. 5. Each step shown in FIG. 5 is performed, for example, by execution of system program 102P1 by processor 101 of main device 100.

FIG. 5 exemplifies processing between main device 100 and a single controller 200 for the sake of convenience of description. When a plurality of controllers 200 are connected to main device 100, however, processing shown in FIG. 5 may be performed for each controller 200. In that case, processing for each controller 200 may be performed in parallel or in series.

Processor 101 of main device 100 executes system program 102P1 to generate time-series vibration instruction data group 114 for each controller 200 in accordance with instructions generated by execution of an application program (for example, game program 102P2). At this time, vibration instructions generated by the application program include identification information that designates controller 200 which is an output destination, or is provided with identification information. Processor 101 specifies controller 200 which is the output destination, based on the identification information.

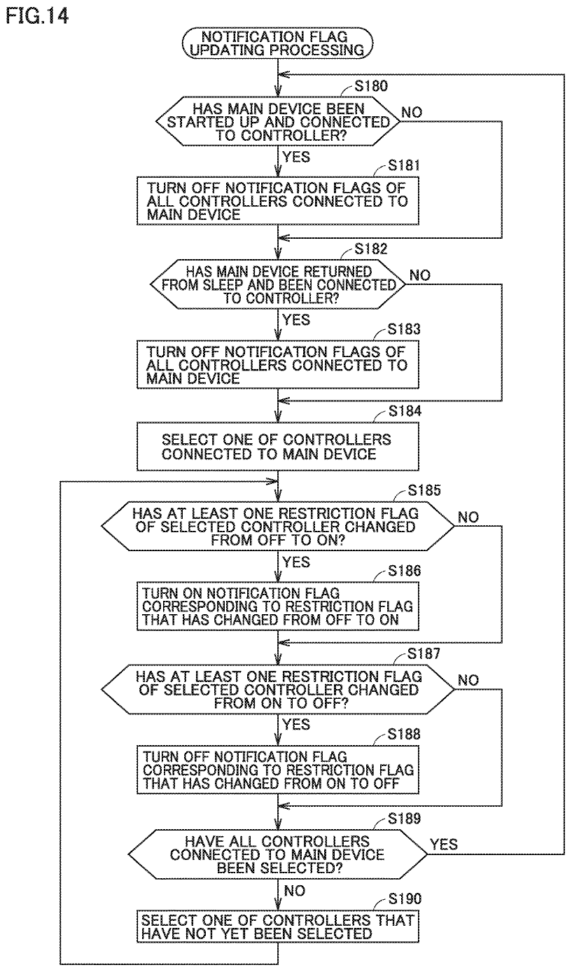

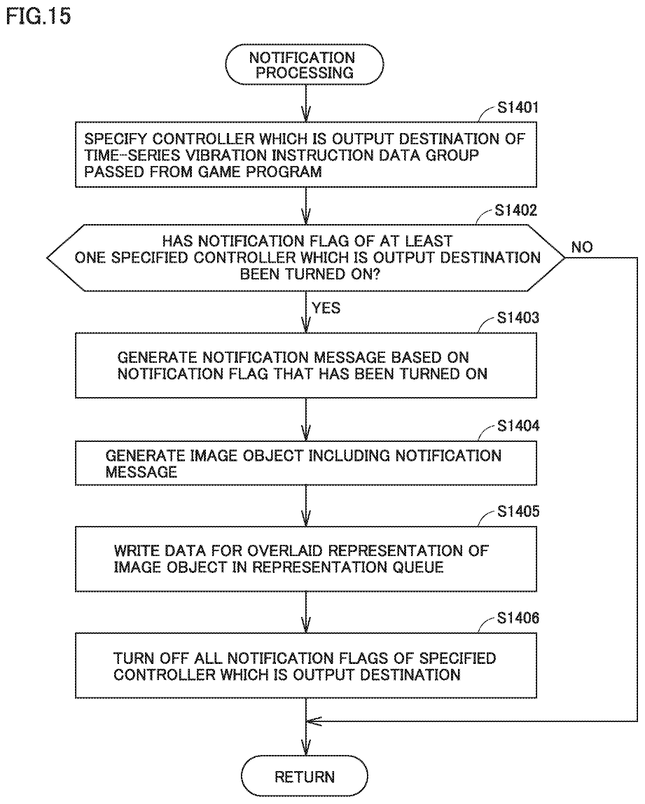

Processor 101 performs notification processing (step S140). The notification processing includes processing for notifying a user of a state in which vibration of vibration motor 206 is restricted in controller 200. Exemplary processing in the notification processing will be described with reference to FIG. 15 which will be described later. In connection with the notification processing, processing for updating a notification flag is performed, in addition to the processing shown in FIG. 5. In the processing for updating the notification flag, on/off of the notification flag (internal temperature notification flag 124, temperature sensor notification flag 125, and remaining battery level notification flag 126) is updated. Exemplary processing in the processing for updating the notification flag will be described with reference to FIG. 14 which will be described later. The processing for updating the notification flag may be a part of the processing shown in FIG. 5.

Processor 101 selects one of pieces of vibration instruction data 116 included in time-series vibration instruction data group 114 passed from game program 102P2 (step S150).

Processor 101 determines an order that has been set for a low-pass filter (which will also be abbreviated as “LPF” below) of controller 200 (step S151). As will be described later, the order of the LPF of controller 200 is changeable, and an example in which the order is set to the fourth order or the sixth order will be described by way of example. The order of the LPF may be set or changed to any value.

In an example where the order of the LPF of controller 200 has been set to the sixth order (“sixth order” in step S151), processor 101 sets a lower limit value of the frequency parameter indicated in time-series vibration instruction data group 114 transmitted to controller 200 to 40 Hz (step S152).

In an example where the order of the LPF of controller 200 has been set to the fourth order (“fourth order” in step S151), processor 101 sets a lower limit value of the frequency parameter to 50 Hz (step S153). In the example where the order of the LPF is set to the fourth order, the lower limit value of the frequency parameter is set to be higher by a predetermined value (for example, 10 Hz) than in the example where the order of the LPF is set to the sixth order. Thus, when the order of the LPF is changed, a margin may be added to a certain range within which the frequency parameter is restricted.

Processor 101 then determines whether or not the frequency parameter in selected vibration instruction data 116 is equal to or smaller than the lower limit value (step S154).

When the frequency parameter is equal to or smaller than the lower limit value (YES in step S154), processor 101 changes the frequency parameter to the lower limit value (step S155). When the frequency parameter is not equal to or smaller than the lower limit value (NO in step S154), processing in step S155 is skipped.

Processing in steps S150 to S155 is processing for restricting the lower limit value of the frequency parameter indicated in time-series vibration instruction data group 114 transmitted to controller 200. Forty hertz or fifty hertz may be an exemplary lower limit frequency allowed in the control data. The lower limit frequency can freely be set depending on amplifier 205 or vibration motor 206 of controller 200. Specifically, in the present embodiment, the frequency characteristics of vibration motor 206 are such that effective vibration is achieved at a frequency higher than approximately 40 Hz and vibration is quite weak when the frequency lowers, for example, to 30 Hz. Therefore, the lower limit frequency that can be used in the application program is set to 40 Hz or 50 Hz.

In step S152, the amplitude parameter may be set to 0. By adopting such processing, the frequency parameter in vibration instruction data 116 is not reflected on processing and hence the instructions are cancelled or deactivated.

Processing in steps S150 to S155 may be included in game program 102P2, rather than system program 102P1.

Processor 101 determines the maximum allowable voltage in accordance with the frequency parameter in selected vibration instruction data 116 (step S156). Processor 101 calculates the voltage amplitude value by multiplying the amplitude parameter (0 to 1) in selected vibration instruction data 116 by the maximum allowable voltage (step S157). Processor 202 thus determines the amplitude value in vibration control data 220 based on change of a maximum amplitude value in accordance with the frequency in the instructions for vibration of vibration motor 206.

Processor 101 writes a set of the calculated voltage amplitude value (amplitude parameter) and the frequency parameter in selected vibration instruction data 116 into vibration instruction data area 103B3 (step S158). Processor 101 writes the set in the area corresponding to controller 200 specified in step S150 which is the output destination. The one or more written sets correspond to time-series vibration instruction data group 110 (or vibration instruction data 112).

Processor 101 determines whether or not it has processed all pieces of vibration instruction data 116 included in time-series vibration instruction data group 114 passed from game program 102P2 (step S159). When all pieces of vibration instruction data 116 included in time-series vibration instruction data group 114 passed from game program 102P2 have not been processed (NO in step S159), processing in step S150 or later is repeated.

When all pieces of vibration instruction data 116 included in time-series vibration instruction data group 114 passed from game program 102P2 have been processed (YES in step S159), the process ends.

The processing shown in FIG. 5 may repeatedly be performed in predetermined cycles or may be performed by being triggered by a predetermined condition being satisfied (for example, passing of time-series vibration instruction data group 114 from game program 102P2).

### [D. Exemplary Processing in Controller 200]

Exemplary processing in controller 200 will now be described.

### (d1: Restriction of Vibration)

Game system 10 according to the present embodiment includes a control system that controls vibration motor 206 implemented by the voice coil motor. The control system according to the present disclosure may be configured with at least a part of game system 10, without being limited to controller 200 alone.

In the control system, for example, when a predetermined condition is satisfied, controller 200 (or processor 202) restricts vibration of vibration motor 206.

Restriction of vibration of vibration motor 206 encompasses at least one of lowering in input voltage to vibration motor 206 and decrease in amount of vibration of vibration motor 206. The amount of vibration may also be rephrased as strength of vibration. Restriction of vibration of vibration motor 206 may encompass stop of vibration motor 206 (including not carrying out control for vibration). As vibration motor 206 is stopped, vibration is not generated.

The predetermined condition may be based, for example, on an estimated temperature of vibration motor 206, a temperature measured by temperature sensor 211, a remaining battery level of battery 212, or the like.

For example, controller 200 may make determination of restriction under a first condition including a condition about the temperature and restriction under a second condition including a condition about the remaining battery level. Controller 200 restricts vibration of vibration motor 206 when at least one of the first condition or the second condition is satisfied.

Processing for generating control data 220 for controlling vibration of vibration motor 206, processing for restricting vibration of vibration motor 206, or the like will be described below. There may be a plurality of types of processing for restricting vibration of vibration motor 206.

### (d2: Processing for Generating Control Data 220)

In controller 200, control data 220 is generated. Control data 220 is data to be inputted to amplifier 205 to control vibration of vibration motor 206. For example, time-series vibration instruction data group 110 is transmitted from main device 100 to controller 200, and processor 202 of controller 200 generates control data 220 based on time-series vibration instruction data group 110. Control data 220 is, for example, data that shows the voltage value of the waveform for driving vibration motor 206 and is outputted or updated in predetermined cycles. Control data 220 may be data that shows an instantaneous value of the voltage in each cycle. The cycle of output or update of control data 220 will also be referred to as a “control cycle” below.

Though the control cycle may be as long as the vibration instruction cycle (for example, 5 msec.), finer control can be realized by making the control cycle shorter than the vibration instruction cycle. In generation of control data 220 in a cycle shorter than the vibration instruction cycle, the control data is generated on the side of controller 200 so that finer control can be realized while an amount of communication between main device 100 and controller 200 is reduced. For example, the control cycle may be set to 1/40 of the vibration instruction cycle (for example, 5 msec.). In other words, the control cycle may be set to 0.125 msec.

Control data 220 indicates the waveform of vibration (for example, a sinusoidal wave). Control data 220 may indicate a rectangular wave or may indicate another waveform depending on a system configuration. Rather than supply of a PWM signal obtained by PWM of the waveform of vibration indicated by control data 220 to vibration motor 206, electric power obtained by amplification of the waveform of vibration indicated in control data 220 as it is may be supplied to vibration motor 206.

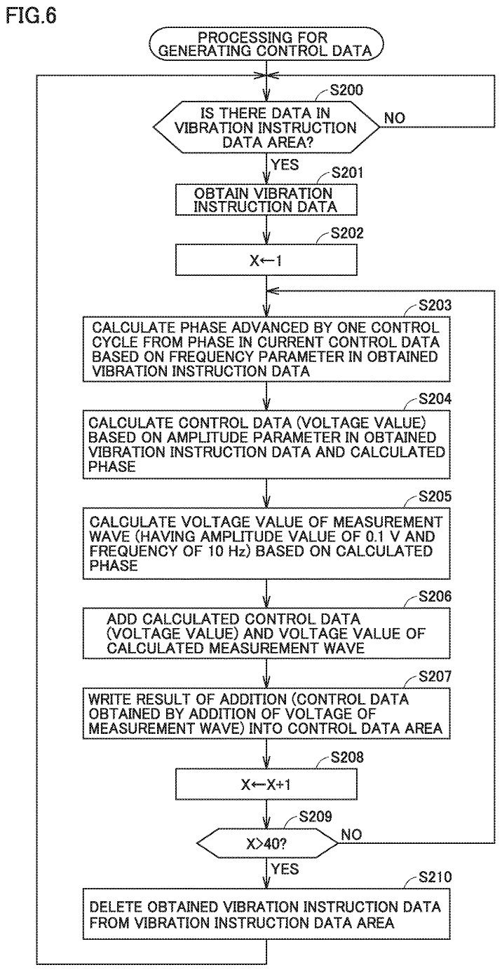

Exemplary processing for generating control data 220 in controller 200 according to the present embodiment will be described with reference to FIG. 6. Each step shown in FIG. 6 is performed, for example, by execution of system program 203P by processor 202 of controller 200. Processing shown in FIG. 6 may repeatedly be performed in predetermined cycles (for example, vibration instruction cycles).

Processing shown in FIGS. 6 to 13 may be performed independently for each controller 200.

Processor 202 determines whether or not there is data in vibration instruction data area 204B1 (step S200). When there is no data in vibration instruction data area 204B1 (NO in step S200), processing in step S200 is repeated.

When there is data in vibration instruction data area 204B1 (YES in step S200), processor 202 obtains vibration instruction data 112 (step S201). At this time, of pieces of data stored in vibration instruction data area 204B1, vibration instruction data 112 at the top (or oldest) is obtained.

Processor 202 sets an index X to one (step S202). Processor 202 calculates the phase advanced by one control cycle (for example, 0.125 msec.) from the phase of current control data (or previously calculated control data) based on the frequency parameter in obtained vibration instruction data 112 (step S203). Processor 202 calculates the control data (voltage value) based on the amplitude parameter in obtained vibration instruction data 112 and the phase calculated in step S203 (step S204).

Immediately after vibration instruction data 112 is newly obtained, the amplitude parameter and the frequency parameter may greatly vary. In such a case, the value of at least one of the amplitude parameter (step S204) or the frequency parameter (step S203) may gradually be varied from the immediately preceding value to the indicated value, rather than application of the indicated value as it is.

Processor 202 calculates the voltage value of the measurement wave (for example, having the amplitude value of 0.1 V and the frequency of 10 Hz) based on the phase calculated in step S203 (step S205). Processor 202 thus generates the measurement wave for estimation of the temperature inside vibration motor 206.

Processor 202 adds the voltage value of the measurement wave calculated in step S205 and the control data (voltage value) calculated in step S204 to each other (step S206). Processor 202 thus generates superimposed control data by superimposing the measurement wave on the control data for vibration of vibration motor 206 implemented by the voice coil motor. The superimposed control data shows the waveform obtained by superimposition of the measurement wave on the waveform in vibration instruction data 112 for driving vibration motor 206.

Processor 202 writes a result of addition (the superimposed control data obtained by superimposition of the voltage of the measurement wave on the control data) into control data area 204B2 (step S207). Processor 202 thus inputs the result of addition (the superimposed control data obtained by superimposition of the voltage of the measurement wave on the control data) to vibration motor 206 implemented by the voice coil motor. Amplifier 205 drives vibration motor 206 based on the result of addition written in control data area 204B2.

Processor 202 increments index X by one (step S208). Processor 202 determines whether or not incremented index X has exceeded forty (step S209).

When incremented index X has not exceeded forty (=vibration instruction cycle/control cycle) (NO in step S209), processing in step S203 or later is repeated. When incremented index X has exceeded forty (YES in step S209), processor 202 deletes vibration instruction data 112 obtained in step S201 from vibration instruction data area 204B1 (step S210). Processing in step S200 or later is then repeated.

In exemplary processing for generating control data 220 according to the present embodiment, the measurement wave at the frequency (for example, 10 Hz) lower than the audible range (for example, 20 Hz to 20,000 Hz) is adopted, and hence hearing from the voice coil motor, of sound resulting from the measurement wave can be avoided. In addition, even when a high frequency cannot be generated and the measurement wave higher than the audible range cannot be used due to processing capability of the processor, the temperature can be estimated. Furthermore, the temperature inside vibration motor 206 can be estimated with less influence on vibration applied to the user.

The frequency of the measurement wave may be set to any frequency, for example, lower than 40 Hz (the lower limit value of the frequency parameter which can be used by the application), without being limited to 10 Hz. In other words, the measurement wave lower than the lower limit frequency in the control data for vibration of vibration motor 206 implemented by the voice coil motor may be adopted. From another point of view, any frequency lower than the audible range may be adopted. The frequency of the measurement wave may be set to 20 Hz or lower, and may be set, for example, to 20 Hz, 15 Hz, or the like, or to 10 Hz or lower. The frequency not higher than 20 Hz may thus be set as the frequency of the measurement wave.

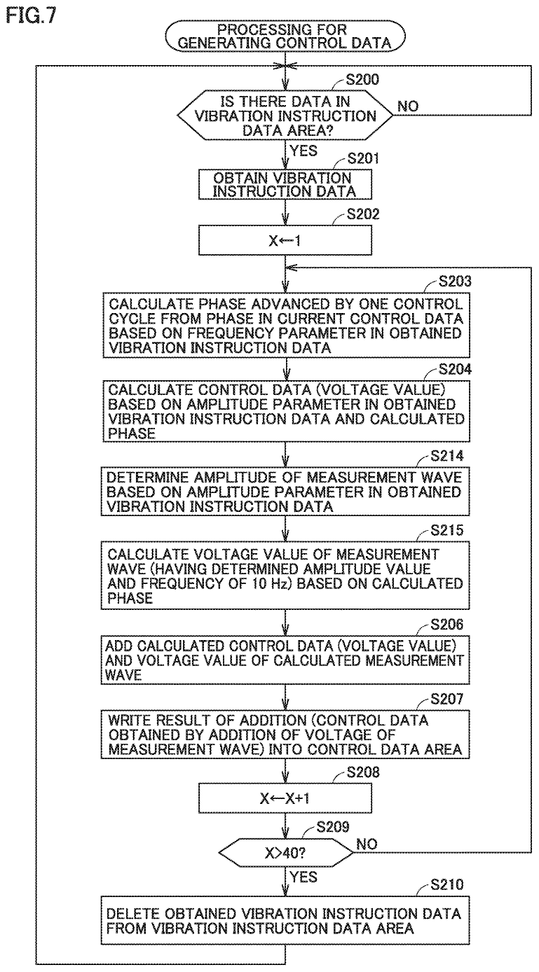

Though the amplitude value of the measurement wave is constant (for example, 0.1 V) in the exemplary generation processing shown in FIG. 6, the amplitude value of the measurement wave may be determined based on the amplitude parameter in vibration instruction data 112. In this case, typically, when the amplitude parameter in vibration instruction data 112 is large, the amplitude value of the measurement wave may be large, and when the amplitude parameter in vibration instruction data 112 is small, the amplitude value of the measurement wave may be small. This modification will be described below with reference to FIG. 7.

Each step shown in FIG. 7 is performed, for example, by execution of system program 203P by processor 202 of controller 200. In the modification shown in FIG. 7, steps S214 and S215 are adopted instead of step S205 in the exemplary generation processing shown in FIG. 6.

Processor 202 determines the amplitude value of the measurement wave based on the amplitude parameter in obtained vibration instruction data 112 (step S214).

Processor 202 thus determines the amplitude value of the measurement wave in accordance with the amplitude value in the control data.

Specifically, for the sake of illustration, for example, when the amplitude parameter in vibration instruction data 112 is equal to or higher than 3 V, the amplitude value of the measurement wave may be set to 0.2 V, and when the amplitude parameter in vibration instruction data 112 is lower than 3 V, the amplitude value of the measurement wave may be set to 0.1 V. Alternatively, a value calculated by multiplying the amplitude parameter in vibration instruction data 112 by a predetermined ratio (for example, 5% or the like) may be determined as the amplitude value of the measurement wave.

Processor 202 calculates the voltage value of the measurement wave based on the phase calculated in step S203 so as to generate the measurement wave (having the amplitude value determined in step S214 and the frequency of 10 Hz) (step S215). Processor 202 thus adaptively determines the voltage value of the measurement wave for estimation of the temperature of vibration motor 206.

Since processing other than that in steps S214 and S215 is similar to corresponding processing in FIG. 6, detailed description will not be repeated.

Accuracy in estimation of the temperature is improved as the amplitude value of the measurement wave is larger. When the amplitude value of the measurement wave becomes too large, however, the user may have an unintended feeling. By dynamically changing the amplitude value of the measurement wave in accordance with magnitude of the amplitude value for vibration to basically be applied to the user as described above, accuracy in estimation of the temperature can be improved and unintended feeling of the measurement wave felt by the user can be lessened.

### (d3: Temperature Estimation Processing and Correction Processing)

Game system 10 according to the present embodiment includes a temperature estimation system that estimates the temperature inside vibration motor 206 implemented by the voice coil motor. For example, controller 200 (or processor 202) estimates the temperature of vibration motor 206 based on a resistance value of vibration motor 206. More specifically, amplifier 205 obtains a current value and a voltage value of vibration motor 206 and outputs them to the MCU. The resistance value and/or temperature are/is calculated based on the current value and the voltage value produced by a signal corresponding to a measurement wave, among these current values and voltage values.

The “measurement wave” herein refers to a signal or a waveform for estimation of the temperature of vibration motor 206. The measurement wave is used for measurement of the resistance value of vibration motor 206. Though the measurement wave is typically a sinusoidal wave, it may be another waveform.

The temperature estimated in temperature estimation processing indicates the temperature inside vibration motor 206, and is used, for example, for prevention of thermal degradation of vibration motor 206.

Though the temperature estimation system according to the present disclosure is executed by processing at a side of controller 200, a part or the entirety thereof may be executed in processing at a side of game system 10.

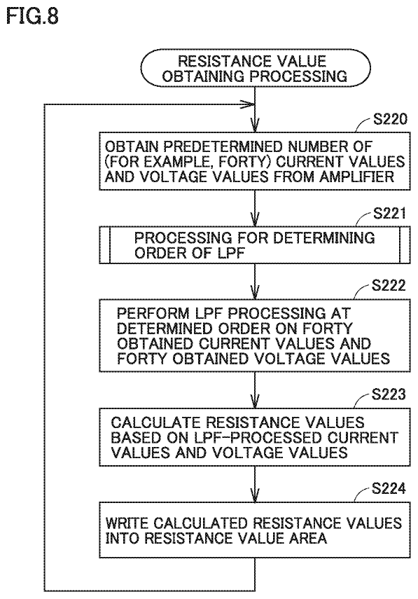

Exemplary processing for obtaining the resistance value for temperature estimation in controller 200 will be described with reference to FIG. 8. Each step shown in FIG. 8 is performed, for example, by execution of system program 203P by processor 202 of controller 200.

Processor 202 obtains from amplifier 205, a predetermined number of (for example, forty) current values and voltage values of vibration motor 206 (step S220). In other words, processor 202 obtains the current values and the voltage values inside vibration motor 206 to which the superimposed control data obtained by superimposition of the measurement wave on the control data has been inputted. For example, forty sets (that is, over 5 msec.) of the current value and the voltage value detected every operation cycle (for example, 0.125 ms) of amplifier 205 may be obtained in the chronological order.

Processor 202 performs processing for determining the order of the LPF (step S221). As the order of the LPF is higher, accuracy in calculation is improved. Processor 202 performs LPF processing at the order determined in step S221, on the forty current values and the forty voltage values obtained in step S220 (step S222). Processor 202 thus performs the LPF processing on the obtained current values and voltage values.

In the LPF processing, for example, a component not higher than 10 Hz is extracted from each of the forty current values (a time waveform of the current values) and the forty voltage values (a time waveform of the voltage values). Through the LPF processing, a component corresponding to the measurement wave calculated in step S205 in FIG. 6 is extracted. Though a filter in any structure may be adopted, for example, an infinite impulse response (IIR) filter or a finite impulse response (FIR) filter can be employed.

By way of example, a second-order IIR digital filter can be described in calculation equations (1) and (2) as below, with an input xₙ and a corresponding output yₙ at time n.

$${u}_{n} = {x}_{n} - {a}_{1} {u}_{n - 1} - {a}_{2} {u}_{n - 2} \qquad ( 1 )$$

$${y}_{n} = {b}_{0} {u}_{n} - {b}_{1} {u}_{n - 1} - {b}_{2} {u}_{n - 2} \qquad ( 2 )$$

uₙ represents a value adopted for the sake of convenience of calculation, and a₁, a₂, b₀, b₁, and b₂ are parameters that determine filter characteristics.

Since the IIR filter according to the equations above is the second-order filter, a fourth-order filter can be implemented by connecting two such filters in series and a sixth-order filter can be implemented by connecting three such filters in series. Connection of the IIR filters in series means use of output yₙ from an IIR filter in a preceding stage as input xₙ to an IIR filter in a subsequent stage. In implementation, at one computation timing, calculation in accordance with the calculation equations (1) and (2) is repeated two times to obtain a result of filtering by the fourth-order filter, and calculation in accordance with the calculation equations (1) and (2) is repeated three times to obtain a result of filtering by the sixth-order filter.

A fourth-order IIR filter and a sixth-order IIR filter may be employed. In this case, the IIR filters do not have to be connected in series. Specifically, an Nth-order IIR digital filter can be described in calculation equations (3) and (4) as below.

$${u}_{n} = {x}_{n} - {a}_{1} {u}_{n - 1} - … - {a}_{2} {u}_{n - N} \qquad ( 3 )$$

$${y}_{n} = {b}_{0} {u}_{n} + {b}_{1} {u}_{n - 1} + … + {b}_{N} {u}_{n - N} \qquad ( 4 )$$

The calculation equation to be used for frequency filtering is thus changed in accordance with change of the order. Change of the calculation equation may be change of the order of the calculation equation. In frequency filtering, as the set order is smaller, calculation load is low. Since the FIR filter is described in a calculation equation different from that of the IIR filter, the calculation equation is changed also when the FIR filter is changed to the IIR filter.

Though the LPF processing is described as exemplary frequency filtering, filtering processing with the use of a band pass filter or a high pass filter may be adopted. Any filter (the LPF, the high pass filter, and the band pass filter) can be used for frequency filtering.

Processor 202 calculates the resistance value based on the LPF-processed current value (the time waveform of the current values) and the LPF-processed voltage value (the time waveform of the voltage values) (step S223). Processor 202 thus calculates the resistance value inside vibration motor 206 implemented by the voice coil motor based on the current value and the voltage value subjected to the LPF processing. The resistance value calculated in step S223 is a value in each cycle (for example, 50 msec.) of execution of temperature estimation processing.

Processor 202 writes the calculated resistance value into resistance value area 204B3 (step S224). Resistance value area 204B3 is configured to store forty resistance values. In this case, resistance values calculated over two seconds (50 msec.×forty) are stored in resistance value area 204B3 in a time-series manner.

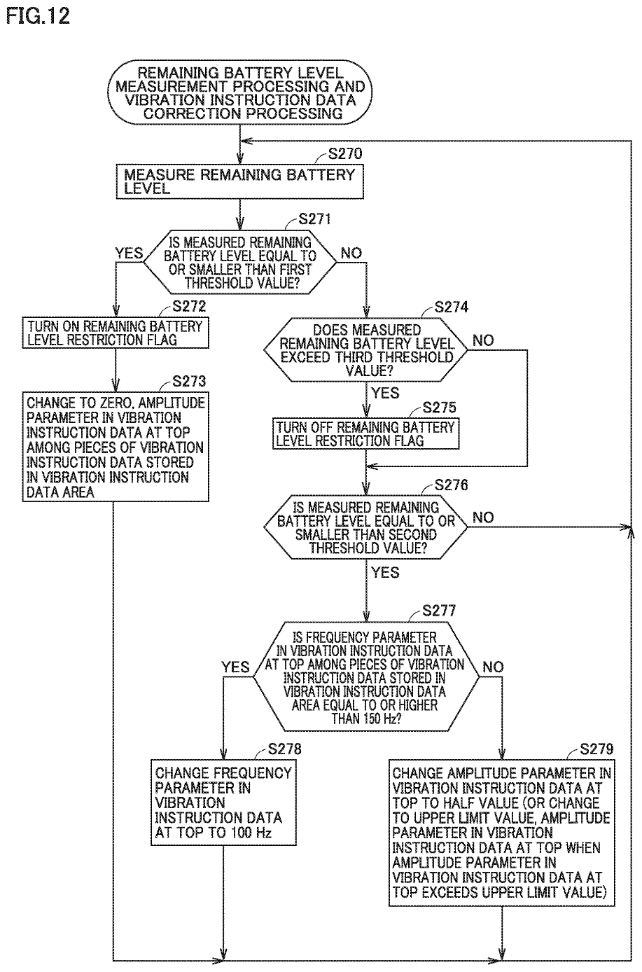

The processing shown in FIG. 8 may repeatedly be performed in predetermined execution cycles (for example, 50 msec.). The cycle of execution of the processing shown in FIG. 8 may be set to be longer than the cycle of execution of temperature measurement by temperature sensor 211 shown in FIG. 12 which will be described later. By setting the cycle of execution of the temperature estimation processing to be longer than the cycle of execution of temperature measurement by temperature sensor 211, load imposed on MCU 201 (processor 202) that has to perform a plurality of types of processing can be lessened while a level of temperature management is maintained.

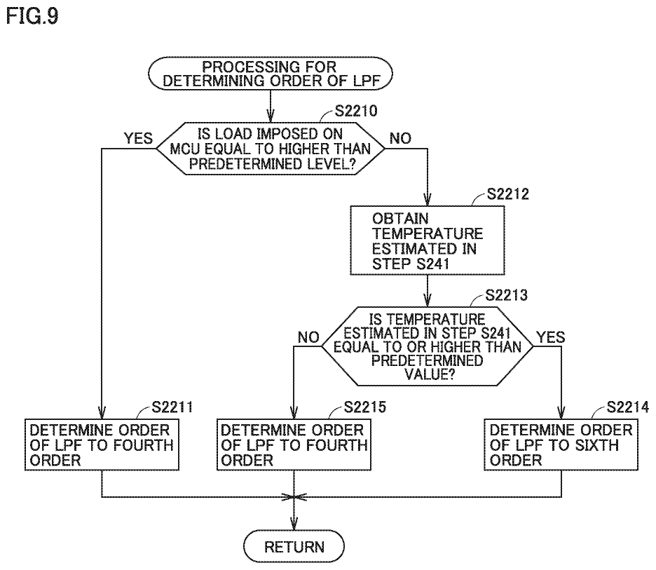

Exemplary further detailed processing in processing for determining the order of the LPF (step S221) shown in FIG. 8 will be described with reference to FIG. 9. Processor 202 determines whether or not load imposed on MCU 201 is equal to or higher than a predetermined level (step S2210). Whether or not load imposed on MCU 201 is equal to or higher than the predetermined level may be determined by adopting one or more of determination methods shown below.
(1) A rate of operation of MCU 201 is measured. When the measured rate of operation is equal to or higher than a predetermined value, load imposed on MCU 201 is determined as being equal to or higher than the predetermined level.
(2) Whether or not MCU 201 is performing predetermined processing is determined. When MCU 201 is performing the predetermined processing, load imposed on MCU 201 is determined as being equal to or higher than the predetermined level. The predetermined processing may be, for example, (a) processing of input to or output from a sensor of controller 200 (for example, a motion sensor (for example, acceleration sensor 208 or gyro sensor 209), a camera, a microphone, an infrared sensor, or the like), (b) processing of input to or output from an external device connected to controller 200, or the like. At least one of the motion sensor, the camera, the microphone, or the infrared sensor may be a peripheral device connectable to controller 200.
(3) In an example where a cycle of communication of the vibration instruction data between main device 100 and controller 200 is variable, when the cycle of communication is equal to or higher than a predetermined level (for example, a communication rate is equal to or higher than a predetermined value, a time interval is equal to or shorter than a predetermined value, or the like), load imposed on MCU 201 is determined as being equal to or higher than the predetermined level.

When load imposed on MCU 201 is equal to or higher than the predetermined level (YES in step S2210), processor 202 sets the order of the LPF to the fourth order (step S2211). Processor 202 thus changes the order of the LPF in accordance with load imposed on MCU 201 (or processor 202 that performs the LPF processing).

When load imposed on MCU 201 is lower than the predetermined level (NO in step S2210), processor 202 obtains the temperature estimated in step S241 (step S2212) and determines whether or not the estimated temperature is equal to or higher than the predetermined value (step S2213).

When the temperature estimated in step S241 is equal to or higher than the predetermined value (YES in step S2213), processor 202 sets the order of the LPF to the sixth order (step S2214). When the temperature estimated in step S241 is not equal to or higher than the predetermined value (NO in step S2213), on the other hand, processor 202 sets the order of the LPF to the fourth order (step S2215). Processor 202 thus changes the order of the LPF in accordance with the estimated temperature.

The temperature estimation processing imposes large load on MCU 201. Therefore, by changing the order of the LPF that determines magnitude of load necessary for execution in accordance with load imposed on MCU 201 as shown in step S2210, influence on another type of processing to be performed by MCU 201 can be lessened.

A processor lower in performance than the processor in the main device may be employed as the processor in the controller. In such a case, load imposed on the processor in the controller should be lowered.

When the temperature attains to a predetermined value or higher as shown in step S2213, the order of the LPF is increased to improve accuracy in estimation of the temperature. When it is not the case, on the other hand, necessity for accuracy in estimation of the temperature is low, and hence the order of the LPF is decreased to lower load necessary for processing. Thus, in a situation where accuracy in estimation of the temperature is not required, load necessary for execution is lowered so that even MCU 201 limited in processing resource can perform a plurality of types of processing in parallel.

A specific numerical value of the order is merely by way of example. In step S2211, for example, the order may be decreased from the fifth order to the third order, or the order may be decreased from the sixth order to the fifth order. The order (the order set in S2211) when load imposed on MCU 201 is high and the order (the order set in S2215) when the estimated temperature is low may be different from each other.

Processing in step S2211 may be performed only when the estimated temperature is lower than the predetermined value. The predetermined value to be used for determination as to whether or not to perform the processing in step S2211 may be set to be higher than the temperature to be used for determination in step S2213. Thus, accuracy in estimation of the temperature may be improved only when the temperature becomes equal to or higher than the predetermined value, and load imposed on MCU 201 may be prevented from increasing when the temperature is lower than the predetermined value.

Processing for decreasing the order of the LPF when load imposed on MCU 201 is equal to or higher than the predetermined level or when the temperature is lower than the predetermined value may be applicable also to an example where the FIR filter is employed as the LPF.

Change from the FIR filter to the IIR filter may be made when load imposed on MCU 201 is equal to or higher than the predetermined level. Change from the FIR filter to the IIR filter may be made when the temperature is lower than the predetermined value. At this time, the order in the calculation equation of the FIR filter may be the same as the order in the calculation equation of the IIR filter. In general, the IIR filter can achieve a greater filtering effect with the lower order (that is, lower calculation load) than the FIR filter.

The vibration instruction data may be corrected based on the estimated temperature. Processing for correcting the vibration instruction data may encompass at least one of processing for restricting vibration of vibration motor 206 or processing for changing the frequency of vibration of vibration motor 206. Processing for changing the frequency of vibration of vibration motor 206 may be regarded as a part of processing for restricting vibration of vibration motor 206 or may be regarded as another type of processing.

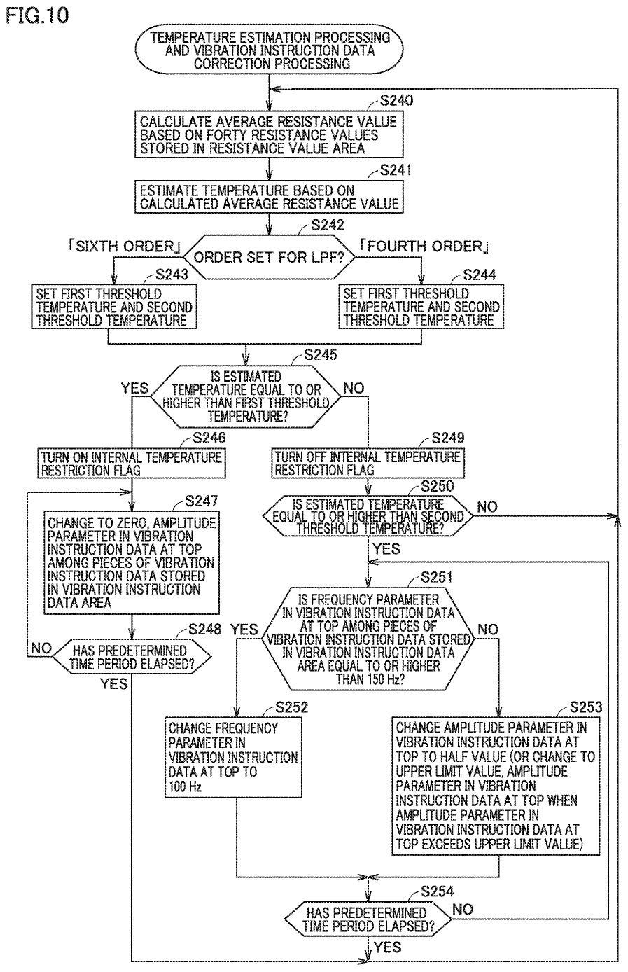

Exemplary processing for estimating the temperature and correcting the vibration instruction data in controller 200 will be described with reference to FIG. 10. Each step shown in FIG. 10 is performed, for example, by execution of system program 203P by processor 202 of controller 200. Processing shown in FIG. 10 may repeatedly be performed in predetermined execution cycles (for example, 50 msec.).

Processor 202 calculates an average resistance value of forty resistance values stored in resistance value area 204B3 (step S240). Rather than the average value, another representative value such as a median value or a mode value may be adopted. Processor 202 estimates the temperature based on the calculated average resistance value (step S241). Processing for estimating the temperature based on the average resistance value may use a predetermined calculation equation or a table in which correspondence between the resistance value and the temperature is defined. As shown in step S240, processor 202 may obtain the current value and the voltage value for a predetermined period or a predetermined number of times and may calculate the resistance value a plurality of times. Processor 202 may then estimate the temperature based on the resistance values calculated the plurality of times.

Processor 202 determines the order that has been set for the LPF (step S242). When the order of the LPF has been set to the sixth order (“sixth order” in step S242), processor 202 sets a first threshold temperature and a second threshold temperature in accordance with the order (sixth order) of the LPF (step S243). In the present embodiment, the first threshold temperature is set to be higher in value than the second threshold temperature.

When the order of the LPF has been set to the fourth order (“fourth order” in step S242), processor 202 sets the first threshold temperature and the second threshold temperature in accordance with the order (fourth order) of the LPF (step S244). In the present embodiment, the first threshold temperature in the case where the order of the LPF is set to the fourth order is set to be smaller in value than the first threshold temperature in the case where the order of the LPF is set to the sixth order. The second threshold temperature in the case where the order of the LPF is set to the fourth order is set to be smaller in value than the second threshold temperature in the case where the order of the LPF is set to the sixth order.

Processor 202 determines whether or not the estimated temperature is equal to or higher than the first threshold temperature (step S245).

When the estimated temperature is equal to or higher than the first threshold temperature (YES in step S245), processor 202 turns on internal temperature restriction flag 221 (step S246). At this time, internal temperature restriction flag 221 indicates the state in which vibration of vibration motor 206 is restricted based on the estimated temperature. Processor 202 then changes the amplitude parameter in vibration instruction data 112 at the top among pieces of vibration instruction data 112 stored in vibration instruction data area 204B1 to zero (step S247). Processor 202 then determines whether or not a predetermined time period has elapsed (step S248). When the predetermined time period has not elapsed (NO in step S248), processing in step S247 or later is repeated. When the predetermined time period has elapsed (YES in step S248), processing in step S240 or later is repeated.

When the estimated temperature is equal to or higher than the first threshold temperature (YES in step S245), the processing in step S248 restricts vibration of vibration motor 206 for a predetermined time period. The predetermined time period may be determined in accordance with a thermal capacity or the like of vibration motor 206.

When the estimated temperature is lower than the first threshold temperature (NO in step S245), processor 202 turns off internal temperature restriction flag 221 (step S249). At this time, internal temperature restriction flag 221 indicates a state in which vibration of vibration motor 206 is not restricted based on the estimated temperature. Processor 202 then determines whether or not the estimated temperature is equal to or higher than the second threshold temperature (step S250). When the estimated temperature is lower than the second threshold temperature (NO in step S250), processing in step S240 or later is repeated.

When the estimated temperature is equal to or higher than the second threshold temperature (YES in step S250), on the other hand, processor 202 changes the frequency of vibration of vibration motor 206 or restricts vibration of vibration motor 206.

More specifically, processor 202 determines whether or not the frequency parameter in vibration instruction data 112 at the top among the pieces of vibration instruction data 112 stored in vibration instruction data area 204B1 is equal to or higher than 150 Hz (step S251).

When the frequency parameter in vibration instruction data 112 at the top is equal to or higher than 150 Hz (YES in step S251), processor 202 changes the frequency parameter in vibration instruction data 112 at the top to 100 Hz (step S252).

When the frequency parameter in vibration instruction data 112 at the top is lower than 150 Hz (NO in step S251), processor 202 decreases the amplitude parameter in vibration instruction data 112 at the top (for example, changes to a half value) (step S253). Processor 202 may change the amplitude parameter in vibration instruction data 112 at the top to an upper limit value only when the amplitude parameter in vibration instruction data 112 at the top exceeds the upper limit value. Restriction of vibration of vibration motor 206 thus includes processing for decreasing the amplitude of the waveform for driving vibration motor 206. Both of a method of frequency shift and a method of reducing magnitude of the amplitude may be adopted as the method of restricting vibration.

Processor 202 then determines whether or not a predetermined time period has elapsed (step S254). When the predetermined time period has not elapsed (NO in step S254), processing in step S251 or later is repeated. When the predetermined time period has elapsed (YES in step S254), processing in step S240 or later is repeated.

When the estimated temperature becomes equal to or higher than the predetermined value, processor 202 may thus restrict vibration of vibration motor 206 implemented by the voice coil motor (S247 or S253).

As shown in step S252, when the estimated temperature becomes equal to or higher than the predetermined value, processor 202 shifts the frequency indicated in the control data for vibration of vibration motor 206 implemented by the voice coil motor to another frequency. Shift of the frequency of vibration motor 206 is processing for shifting the frequency of the waveform for driving vibration motor 206 to a frequency higher in vibration efficiency. As will be understood with reference to FIG. 3, vibration motor 206 in the present embodiment has such characteristics as being most likely to vibrate at the frequency of 100 Hz (or such characteristics as being large in vibration even at a low drive voltage).

More specifically, in the exemplary frequency characteristics shown in FIG. 3, the amount of vibration relative to a certain input voltage in the vicinity of 100 Hz (for example, from approximately 50 Hz to approximately 150 Hz) is higher than the amount of vibration relative to the input voltage at frequencies (for example, not higher than approximately 50 Hz and not lower than approximately 150 Hz) other than that. In step S252, processor 202 changes the indicated frequency parameter such that the amount of vibration relative to the input voltage at the changed frequency is higher than the amount of vibration at the indicated frequency. The frequency in the vicinity of 100 Hz can also be concluded as the frequency at which the same amount of vibration can be achieved at a lower voltage.

In step S247, control data 220 present in control data area 204B2 may be changed to zero. In step S248, rather than lapse of the predetermined time period, the temperature estimated by performing again step S240 and step S241 (or the temperature measured by temperature sensor 211) reaching a predetermined threshold temperature or lower may be awaited.

Determination processing in step S245 and determination processing in step S250 may be performed in any order. Processing (steps S247, S252, and S253) corresponding to those determinations may also be performed in any order.

When high electric power is supplied to vibration motor 206, the resistance value of vibration motor 206 instantaneously increases. Even occurrence of such instantaneous increase in resistance value less affects thermal degradation of vibration motor 206. Therefore, as shown in step S240, vibration of vibration motor 206 is restricted based on a result of averaging of the resistance values over a predetermined period. Output from vibration motor 206 can thus instantaneously be increased.

In the example where the frequency of the measurement wave is low, accuracy in estimation of the temperature is lower as a period for estimation is shorter. Therefore, accuracy in estimation of the temperature can be improved by using an average value of the plurality of resistance values over a longer period as shown in step S240.

### (d4: Temperature Measurement Processing and Vibration Restriction Processing)

Game system 10 according to the present embodiment can measure the temperature with temperature sensor 211. For example, the temperature measured by temperature sensor 211 may represent the temperature outside vibration motor 206, which is an internal temperature of controller 200 and/or a surface temperature of controller 200. The vibration instruction data may be corrected based on the measured temperature.

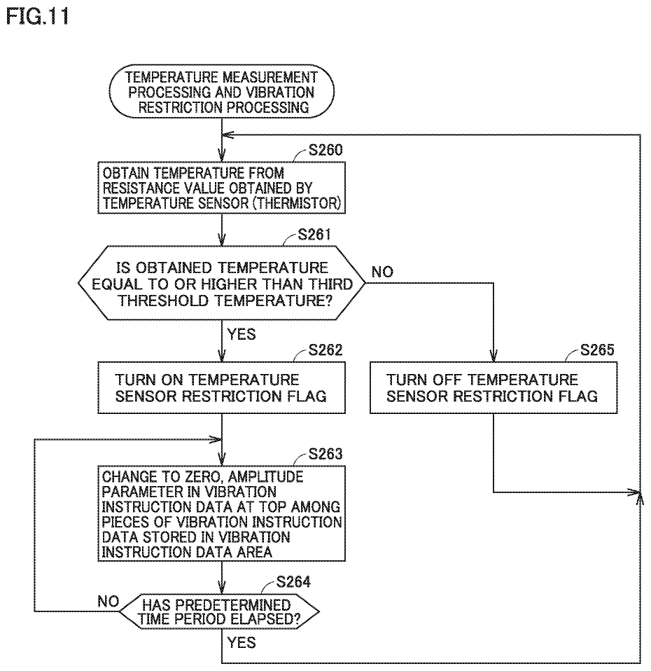

Exemplary temperature measurement processing and exemplary vibration restriction processing in controller 200 will be described with reference to FIG. 11. Each step shown in FIG. 11 is performed, for example, by execution of system program 203P by processor 202 of controller 200. Processing shown in FIG. 11 may repeatedly be performed in predetermined execution cycles (for example, 5 msec.).

Processor 202 obtains the temperature based on the resistance value from temperature sensor 211 (for example, the thermistor) (step S260). Specifically, processor 202 measures the temperature with temperature sensor 211 arranged outside vibration motor 206.

Processor 202 determines whether or not the temperature measured with temperature sensor 211 is equal to or higher than a third threshold temperature (step S261). In the present embodiment, the third threshold temperature is set to a value smaller than the first threshold temperature.

When the obtained temperature is equal to or higher than the third threshold temperature (YES in step S261), processor 202 turns on temperature sensor restriction flag 222 (step S262). At this time, temperature sensor restriction flag 222 indicates a state in which vibration of vibration motor 206 is restricted based on the measured temperature. Processor 202 then changes to zero, an amplitude parameter in vibration instruction data 112 at the top among pieces of data stored in vibration instruction data area 204B1 (step S263). In succession, processor 202 determines whether or not a predetermined time period has elapsed (step S264). When the predetermined time period has not elapsed (NO in step S264), processing in step S263 or later is repeated. When the predetermined time period has elapsed (YES in step S264), processing in step S260 or later is repeated.

When the obtained temperature is equal to or higher than the third threshold temperature (YES in step S261), the processing in step S264 restricts vibration of vibration motor 206 is restricted. Since determination is made every execution cycle (for example, 5 msec.), the time period in which vibration is restricted is an integral multiple of the execution cycle.

In a modification, the period in which vibration is restricted may be determined in accordance with a thermal capacity or the like of vibration motor 206. In this case, the time period in which vibration is restricted may be determined by measurement.

When the obtained temperature is lower than the third threshold temperature (NO in step S261), processor 202 turns off temperature sensor restriction flag 222 (step S265). At this time, temperature sensor restriction flag 222 indicates a state in which vibration of vibration motor 206 is not restricted based on the measured temperature. Processing in step S260 or later is then repeated.

In step S263, rather than changing the amplitude parameter to zero, the amplitude parameter may be decreased or a frequency parameter may be shifted (that is, the indicated frequency may be changed) as shown in step S253 or S252 (see FIG. 10 in each case). Processor 202 may thus restrict vibration of vibration motor 206 implemented by the voice coil motor (S263) when the temperature measured with temperature sensor 211 becomes equal to or higher than a predetermined value.

When the temperature measured with temperature sensor 211 becomes equal to or higher than the third threshold temperature as shown in FIG. 11, processor 202 stops drive of vibration motor 206. The cycle of execution of the processing shown in FIG. 11 is, for example, 5 msec. Therefore, the cycle (5 msec.) of measurement of the temperature with temperature sensor 211 is shorter than the cycle of estimation of the temperature (the cycle of execution of the processing shown in FIG. 10 being, for example, 50 msec.) based on the resistance value. By thus making the execution cycles different, a frequency of performing temperature estimation processing high in load imposed on MCU 201 can be lowered.

### (d5: Remaining Battery Level Measurement Processing and Correction Processing)

Game system 10 according to the present embodiment can measure the remaining battery level of battery 212 of controller 200. The vibration instruction data may be corrected based on the measured remaining battery level.

Exemplary remaining battery level measurement processing and exemplary vibration instruction data correction processing in controller 200 according to the present embodiment will be described with reference to FIG. 12. Each step shown in FIG. 12 is performed, for example, by execution of system program 203P by processor 202 of controller 200. Processing shown in FIG. 12 may repeatedly be performed in predetermined execution cycles (for example, 50 msec.). Description of processing similar to the processing shown in FIG. 10 will not be repeated.

Processor 202 measures the remaining battery level of battery 212 (step S270). The remaining battery level may be measured with any method. For example, the remaining battery level may be calculated by monitoring values of the current and the voltage generated during charging and discharging of battery 212 or based on the value of the voltage exhibited by battery 212.

Processor 202 determines whether or not the measured remaining battery level is equal to or smaller than a first threshold value (step S271).

When the measured remaining battery level is equal to or smaller than the first threshold value (YES in step S271), processor 202 turns on remaining battery level restriction flag 223 (step S272). At this time, remaining battery level restriction flag 223 indicates a state in which vibration of vibration motor 206 is restricted based on the remaining battery level of battery 212. Processor 202 then changes the amplitude parameter in vibration instruction data 112 at the top among the pieces of vibration instruction data 112 stored in vibration instruction data area 204B1 to zero (step S273). Processing in step S270 or later is then repeated.

When the measured remaining battery level is higher than the first threshold value (NO in step S271), processor 202 determines whether or not the measured remaining battery level exceeds the third threshold value (step S274). When the measured remaining battery level exceeds a third threshold value (YES in step S274), processor 202 turns off remaining battery level restriction flag 223 (step S275). At this time, remaining battery level restriction flag 223 indicates a state in which vibration of vibration motor 206 is not restricted based on the remaining battery level of battery 212.

When the measured remaining battery level does not exceed the third threshold value (NO in step S274), processing in step S275 is skipped.

In the present embodiment, the third threshold value is set to be higher than the first threshold value. In other words, the third threshold value for setting remaining battery level restriction flag 223 from on to off is higher than the first threshold value for setting remaining battery level restriction flag 223 from off to on. Therefore, the remaining battery level at which remaining battery level restriction flag 223 is turned on does not match with the remaining battery level at which remaining battery level restriction flag 223 is turned off, and they have hysteresis. As determination as to the remaining battery level has hysteresis, possibility of repetition of on and off of remaining battery level restriction flag 223 in a short period of time can be lowered.

Processor 202 then determines whether or not the measured remaining battery level is equal to or smaller than a second threshold value (step S276). In the present embodiment, the second threshold value is set to be higher than the first threshold value. When the measured remaining battery level is higher than the second threshold value (NO in step S276), processing in step S270 or later is repeated.

When the measured remaining battery level is equal to or smaller than the second threshold value (YES in step S276), on the other hand, processor 202 changes the frequency of vibration of vibration motor 206 or restricts vibration of vibration motor 206.

More specifically, processor 202 determines whether or not the frequency parameter in vibration instruction data 112 at the top among the pieces of vibration instruction data 112 stored in vibration instruction data area 204B1 is equal to or higher than 150 Hz (step S277).

When the frequency parameter in vibration instruction data 112 at the top is equal to or higher than 150 Hz (YES in step S277), processor 202 changes the frequency parameter in vibration instruction data 112 at the top to 100 Hz (step S278). Processing in step S270 or later is then repeated.

When the measured remaining battery level becomes equal to or smaller than the predetermined value, processor 202 thus shifts the frequency indicated in the control data for vibration of vibration motor 206 implemented by the voice coil motor to another frequency. Shift of the frequency of vibration motor 206 is processing for shifting the frequency of the waveform for driving vibration motor 206 to the frequency higher in vibration efficiency.

When the frequency parameter in vibration instruction data 112 at the top is lower than 150 Hz (NO in step S277), processor 202 decreases the amplitude parameter in vibration instruction data 112 at the top (for example, changes to a half value) (step S279). Processing in step S270 or later is then repeated.

When the measured remaining battery level becomes equal to or smaller than the predetermined value, processor 202 may thus restrict vibration of vibration motor 206 implemented by the voice coil motor (S273 or S279).

Processor 202 may change the amplitude parameter in vibration instruction data 112 at the top to the upper limit value only when the amplitude parameter in vibration instruction data 112 at the top exceeds the upper limit value. Restriction of vibration of vibration motor 206 thus encompasses processing for decreasing the amplitude of the waveform for driving vibration motor 206. Shift of the frequency may be combined as the method of restricting vibration.

In step S273, control data 220 present in control data area 204B2 may be changed to zero.

Determination processing in step S271, determination processing in step S274, and determination processing in step S276 may be performed in any order. Processing (steps S273, S275, and S277) corresponding to those determinations may also be performed in any order.

The third threshold value may be equal to the second threshold value. Since determination processing in step S274 and determination processing in S276 are the same processing in this case, one of them does not have to be performed.

### (d6: Adjustment Between Processing for Correcting Vibration Instruction Data)

Both or only one of processing for correcting the vibration instruction data based on the estimated temperature shown in FIG. 10 and processing for correcting the vibration instruction data based on the remaining battery level shown in FIG. 12 may be performed.

Every predetermined execution cycle, after the processing for correcting the vibration instruction data based on the estimated temperature shown in FIG. 10 is performed, the processing for correcting the vibration instruction data based on the remaining battery level shown in FIG. 12 may be performed. In contrast, every predetermined execution cycle, after the processing for correcting the vibration instruction data based on the remaining battery level shown in FIG. 12 is performed, the processing for correcting the vibration instruction data based on the estimated temperature shown in FIG. 10 may be performed. The processing for correcting the vibration instruction data shown in FIG. 10 may be different in execution cycle from the processing for correcting the vibration instruction data shown in FIG. 12.

When correction processing shown in FIG. 10 and correction processing shown in FIG. 12 are performed, adjustment processing as below may be performed.
(1) When at least one of step S247 in FIG. 10 or step S273 in FIG. 12 is performed, the amplitude parameter in vibration instruction data 112 at the top is changed to zero.
(2) When neither of step S247 in FIG. 10 and step S273 in FIG. 12 is performed and when at least one of step S252 in FIG. 10 or step S278 in FIG. 12 is performed, the frequency parameter in vibration instruction data 112 at the top is changed to 100 Hz.
(3) When neither of step S247 in FIG. 10 and step S272 in FIG. 12 is performed, when neither of step S252 in FIG. 10 and step S278 in FIG. 12 is performed, and when at least one of step S253 in FIG. 10 or step S279 in FIG. 12 is performed, the amplitude parameter in vibration instruction data 112 at the top is decreased (for example, changed to a half value).

Thus, when determination to make different corrections of the vibration instruction data is made for the correction processing, determination in certain correction processing may be prioritized in accordance with a predetermined adjustment rule. The order of adjustment rules shown in (1) to (3) can be modified as appropriate.

### (d7: Modification)

At least one of the processing for correcting the vibration instruction data based on the estimated temperature described above (FIG. 10) or the processing for correcting the vibration instruction data based on the remaining battery level (FIG. 12) may be modified as below.

Though exemplary processing for changing the frequency in steps S252 and S278 described above when the obtained frequency parameter is equal to or higher than 150 Hz is shown, in a modification, one of change of the frequency and restriction of vibration of vibration motor 206 may be selected depending on the indicated frequency. In other words, the frequency may be changed while the indicated frequency is within a range, and vibration of vibration motor 206 may be restricted while the indicated frequency is out of the range. For example, when the obtained frequency parameter is equal to or higher than 300 Hz, the amplitude parameter may be changed to zero without changing the value of the frequency parameter.

Though exemplary processing for changing the frequency in steps S252 and S278 described above when the obtained frequency parameter is equal to or higher than 150 Hz is shown, in a modification, the frequency does not have to be changed while the indicated frequency is within the range. For example, while the obtained frequency parameter is within a range from 50 Hz to 150 Hz, the value of the frequency parameter may be maintained.

Though an example in which the frequency parameter is changed to a fixed value (for example, 100 Hz) in steps S252 and S278 described above is shown, in a modification, the changed frequency may be determined in accordance with the indicated frequency. For example, when the obtained frequency parameter indicates 200 Hz, the frequency may be changed to 100 Hz, and when the obtained frequency parameter indicates 300 Hz, the frequency may be changed to 125 Hz.

Though the example in which the frequency parameter is changed to a fixed value (for example, 100 Hz) in steps S252 and S278 described above is shown, in a modification, the changed frequency may be determined in accordance with the temperature estimated in the temperature estimation processing (or the temperature measured with temperature sensor 211). For example, when the estimated temperature (or the measured temperature) is equal to or higher than the first threshold temperature (see steps S243 and S244) while the obtained frequency parameter indicates 150 Hz, the frequency may be changed to 100 Hz, and when the estimated temperature (or the measured temperature) is lower than the first threshold temperature and equal to or higher than the second threshold temperature, the frequency may be changed to 125 Hz. The first threshold temperature and the second threshold temperature (which is lower than the first threshold temperature) may be set independently of the first threshold temperature and the second threshold temperature set in steps S243 and S244.

Only a part of each modification above may be adopted, or the modifications may be combined as appropriate.

### (d8: Combination)

The correction processing for the vibration motor described above and the modifications thereof can be combined as appropriate.

### [E. Notification Processing]

Game system 10 according to the present embodiment can also notify the user of the state in which vibration is restricted. In the notification processing, the user may be notified of restriction of vibration of vibration motor 206, together with a reason based on determination to restrict vibration (for example, step S245 in FIG. 10, step S261 in FIG. 11, steps S271 and S274 in FIG. 12, or the like). Exemplary notification processing will be described below.

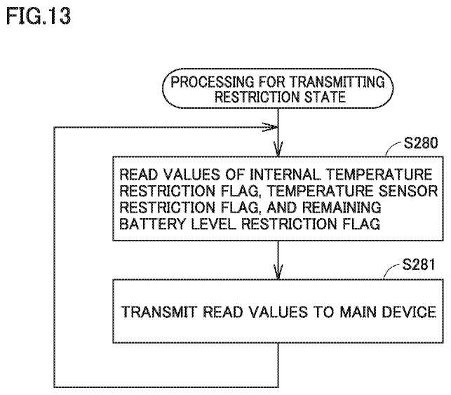

Exemplary processing for transmitting the restriction state in controller 200 will be described with reference to FIG. 13. Each step shown in FIG. 13 is performed, for example, by execution of system program 203P by processor 202 of controller 200. Processing shown in FIG. 13 may repeatedly be performed every predetermined communication cycle (for example, 5 msec.).

Processor 202 reads values of internal temperature restriction flag 221, temperature sensor restriction flag 222, and remaining battery level restriction flag 223 stored in flag area 204B5 (step S280), and transmits the read values to main device 100 (step S281). The read values indicate results of determination for restriction of vibration of vibration motor 206 shown in FIGS. 10 to 12.

Though exemplary processing for independently transmitting the restriction flag (internal temperature restriction flag 221, temperature sensor restriction flag 222, and remaining battery level restriction flag 223) indicating the restriction state is shown for the sake of convenience, the restriction flag may periodically be transmitted from controller 200 to main device 100 together with operation data. The restriction flag may be transmitted when the value thereof changes, rather than being periodically transmitted.

Main device 100 stores the restriction state (for example, values of internal temperature restriction flag 221, temperature sensor restriction flag 222, and remaining battery level restriction flag 223) received from each of controllers 200 in flag set 120 corresponding to that controller 200. Specifically, the values of internal temperature restriction flag 221, temperature sensor restriction flag 222, and remaining battery level restriction flag 223 of corresponding controller 200 are reflected on the values of internal temperature restriction flag 121, temperature sensor restriction flag 122, and remaining battery level restriction flag 123, respectively.

Main device 100 notifies the user of restriction of vibration of vibration motor 206 based on the restriction state of each controller 200.

Exemplary processing for updating the notification flag in main device 100 will be described with reference to FIG. 14. Each step shown in FIG. 14 is performed, for example, by execution of system program 102P1 by processor 101 of main device 100.

Processor 101 determines whether or not main device 100 has been started up and connected to controller 200 (step S180). When main device 100 has been started up and connected to controller 200 (YES in step S180), processor 101 turns off the notification flag (internal temperature notification flag 124, temperature sensor notification flag 125, or remaining battery level notification flag 126) of all controllers 200 connected to main device 100 (step S181).

When main device 100 has not been connected to controller 200 although it has been started up (NO in step S180), processing in step S181 is skipped.

Processor 101 determines whether or not main device 100 has returned from sleep and been connected to controller 200 (step S182). When main device 100 has returned from sleep and been connected to controller 200 (YES in step S182), processor 101 turns off the notification flags of all controllers 200 connected to main device 100 (step S183).

When main device 100 has not been connected to controller 200 although it has returned from sleep (NO in step S182), processing in step S183 is skipped.

Processor 101 selects one of controllers 200 connected to main device 100 (step S184).

Processor 101 determines whether or not at least one restriction flag (internal temperature restriction flag 121, temperature sensor restriction flag 122, and remaining battery level restriction flag 123) of selected controller 200 has changed from off to on (step S185). Change of the restriction flag from off to on encompasses being off in previous determination and being on in present determination.

When at least one restriction flag has changed from off to on (YES in step S185), processor 101 turns on the notification flag corresponding to the restriction flag that has changed from off to on (step S186). When at least one of the estimated temperature, the measured temperature, or the remaining battery level satisfies a corresponding condition as a result of this processing, notification of restriction of vibration is provided.

When none of the restriction flags has changed from off to on (NO in step S185), processing in step S186 is skipped.

Processor 101 determines whether or not at least one restriction flag of selected controller 200 has changed from on to off (step S187). Change of the restriction flag from on to off encompasses being on in previous determination and being off in present determination.

When at least one restriction flag has changed from on to off (YES in step S187), processor 101 turns off the notification flag corresponding to the restriction flag that has changed from on to off (step S188).

When none of the restriction flags has changed from on to off (NO in step S187), processing in step S188 is skipped.

Processor 101 determines whether or not all controllers 200 connected to main device 100 have been selected (step S189). When there is controller 200 that has not yet been selected among controllers 200 connected to main device 100 (NO in step S189), processor 101 selects one of unselected controllers 200 (step S190). Processing in step S185 or later is then performed.

When all controllers 200 connected to main device 100 have been selected (YES in step S189), processing in step S180 or later is repeated.

Exemplary processing in the notification processing (step S140) shown in FIG. 5 will be described with reference to FIG. 15. Processor 101 specifies controller 200 which is the output destination of time-series vibration instruction data group 114 passed from game program 102P2 (S1401). In processing in step S1401, processor 101 specifies controller 200 which is the output destination of time-series vibration instruction data group 114 (or vibration instruction data 116) that has been passed from game program 102P2 but has not yet been transmitted. In other words, when there is vibration instruction data 116 that has not yet been transmitted to controller 200 which is the output destination, processor 101 specifies controller 200 to which vibration instruction data 116 is to be transmitted.

When there is no time-series vibration instruction data group 114 (or vibration instruction data 116) passed from game program 102P2 in step S1401, processing in step S1402 or later may be skipped. When the vibration instructions from game program 102P2 are thus provided to at least one controller 200 and when vibration of vibration motor 206 is restricted in that controller 200, notification of restriction of vibration may be provided. In other words, unless the vibration instructions from game program 102P2 are provided, even when vibration of vibration motor 206 is restricted in at least one controller 200, notification of restriction of vibration does not have to be provided.

Processor 101 determines whether or not at least one notification flag of controller 200 which is the output destination of the vibration instruction data specified in step 1401 has been turned on (step S1402). When at least one notification flag of specified controller 200 which is the output destination has been turned on (YES in step S1402), processor 101 generates text to be used for a notification message based on the notification flag that has been turned on (step S1403). At this time, text different between when internal temperature notification flag 124 or temperature sensor notification flag 125 has been turned on and when remaining battery level notification flag 126 has been turned on is generated. Processor 101 thus provides the user with the notification that vibration of the vibration motor is restricted, in a manner different between when the first condition including the condition about the temperature is satisfied and when the second condition including the condition about the remaining battery level is satisfied.

Processor 101 specifies identification information and model information of specified controller 200 which is the output destination and a player number allocated to specified controller 200 which is the output destination, and generates an image object representing such information in accordance with the text (step S1404). Processor 101 writes data for overlaid representation of the image object in representation queue 103B5 (step S1405).

When a plurality of notification flags of specified controller 200 which is the output destination have been turned on (for example, remaining battery level restriction flag 123 and internal temperature notification flag 124 are both on), data for overlaid representation may be generated based on one notification flag in accordance with predetermined priority, or data for overlaid representation may be generated based on all notification flags that have been turned on.

Processor 101 or a not-shown image processing circuit or image processor realizes overlaid representation based on the data written in representation queue 103B5.

Processor 101 turns off all notification flags of specified controller 200 which is the output destination (step S1406). In the exemplary processing for updating the notification flag shown in FIG. 14, change of the restriction flag from off to on is defined as the condition for updating the notification flag. Accordingly, while the restriction flag is maintained on, the corresponding notification flag is not turned on again. Therefore, the notification can be prevented from being provided again for the same reason after notification of restriction of vibration for the same reason is provided.

Even when further vibration instructions are provided from game program 102P2 while restriction of vibration of vibration motor 206 continues, notification again is suppressed. Possibility that the user feels bothered can thus be reduced.

When vibration of vibration motor 206 is restricted again based on the estimated temperature, the measured temperature, the remaining battery level, or the like after restriction of vibration of vibration motor 206 is released, on the other hand, the restriction flag changes from off to on and hence the corresponding notification flag also changes from off to on. Therefore, when the vibration instructions are provided from game program 102P2, notification of restriction of vibration is again provided.

When none of the notification flags of specified controller 200 which is the output destination has been turned on (NO in step S1402), processing in steps S1403 to S1406 is skipped.

Regardless of contents executed in the notification processing, processing in step S150 or later shown in FIG. 5 may be performed, or transmission per se of the vibration instruction data may be stopped when vibration is restricted in controller 200 which is the output destination.

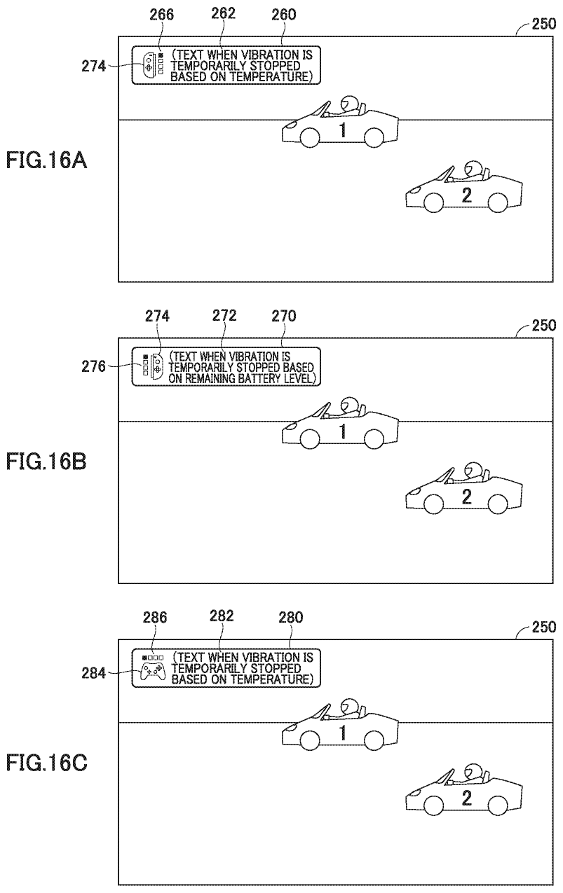

Exemplary representation in the notification processing (step S140) shown in FIG. 5 will be described with reference to FIGS. 16A to 16C. In FIGS. 16A to 16C, for example, a first user to which a player number “1” is allocated is assumed to operate controllers 200 with left and right hands and a second user to which a player number “2” is allocated is assumed to operate a single controller 200.

A game picture 250 shown in FIGS. 16A to 16C includes an image generated by running game program 102P2.

In FIG. 16A, an image object 260 is shown as being superimposed on game picture 250. Image object 260 notifies, for example, that vibration of vibration motor 206 is restricted based on the temperature condition in controller 200 operated with the left hand of the first user. Image object 260 includes, for example, text 262 including the fact that vibration is restricted and a reason for restriction of vibration, an icon 274 indicating controller 200 where vibration is restricted, and identification representation 266 indicating the player number allocated to controller 200. Icon 274 indicates identification information of controller 200 where vibration is restricted. Icon 274 may be generated or selected based on the identification information of controller 200 or the model information of controller 200.

For an example where vibration of vibration motor 206 is restricted based on the estimated temperature and an example where vibration of vibration motor 206 is restricted based on the temperature measured with temperature sensor 211, the same text may be outputted or text that allows distinction therebetween may be outputted.

In FIG. 16B, an image object 270 is shown as being superimposed on game picture 250. Image object 270 notifies, for example, that vibration of vibration motor 206 is restricted based on the remaining battery level condition in controller 200 operated with the right hand of the first user. Image object 270 includes text 272, an icon 274 indicating controller 200 where vibration is restricted, and identification representation 276 indicating the player number allocated to controller 200.

In FIG. 16C, an image object 280 is shown as being superimposed on game picture 250. Image object 280 notifies, for example, that vibration of vibration motor 206 is restricted based on the temperature condition in controller 200 operated by the second user. Image object 280 includes, for example, text 282, an icon 284 indicating controller 200 where vibration is restricted, and identification representation 286 indicating the player number allocated to controller 200.

As shown in FIGS. 16A to 16C, notification of restriction of vibration of vibration motor 206 is provided together with the reason for restriction of vibration of vibration motor 206.

The image object may disappear after lapse of a predetermined time period or may be kept shown until the user performs some operation.

Exemplary representation shown in FIGS. 16A to 16C is by way of example, and the user may be notified in any form of representation. Instead of or in addition to representation, the user may be notified by sound or another actuator.

Though FIGS. 16A to 16C show icons 274, 284 indicating the identification information of controller 200, an identification number, an identification name, a model name, or the like may be shown as the identification information of controller 200.

In the notification processing, when restriction of vibration is released, the user may be notified of that fact. In this case, the user may be notified that restriction of vibration is released only when the vibration instruction data is transmitted from main device 100 to controller 200, or the user may be notified that restriction of vibration is released without transmission of the vibration instruction data. The notification of release of restriction of vibration may be provided with any method.

### [F. Modification]

Though exemplary processing in which the game program by way of example of the application program generates the vibration instruction data is shown in the description above, any application program can generate the vibration instruction data, without being limited to the game program.

Though FIG. 1 shows an exemplary configuration in which main device 100 includes a single processor 101, main device 100 may include a plurality of processors 101. Similarly, though an exemplary configuration in which MCU 201 of controller 200 includes a single processor 202 is shown, MCU 201 may include a plurality of processors 202.

Though FIG. 1 shows an exemplary configuration in which main device 100 includes a single non-volatile memory 102 and a single volatile memory 103, main device 100 may include a plurality of non-volatile memories 102 and/or a plurality of volatile memories 103. Similarly, an exemplary configuration in which MCU 201 of controller 200 includes a single non-volatile memory 203 and a single volatile memory 204, MCU 201 may include a plurality of non-volatile memories 203 and/or a plurality of volatile memories 204.

Though an exemplary configuration in which processing is performed as being allocated between processor 101 of main device 100 and MCU 201 (processor 202) of controller 200 is described above, only processor 101 of main device 100 (or MCU 201 (processor 202) of controller 200) may perform the processing.

Allocation of the processing between processor 101 of main device 100 and MCU 201 (processor 202) of controller 200 is by way of example, and processing may freely be allocated therebetween. For example, the processing for generating control data 220 may be performed in main device 100.

For example, when controller 200 receives the vibration instruction data while vibration of vibration motor 206 is restricted (for example, at least one of internal temperature restriction flag 221, temperature sensor restriction flag 222, or remaining battery level restriction flag 223 is on), it may instruct main device 100 to perform the notification processing. In other words, whether or not to perform the notification processing may be determined at the side of controller 200.

The program encompasses a source code, an intermediate code, an object code, a native code, a script, and the like, and a type of the code is not limited. The program may run on an interpreter or an emulator.

The program may be executed by a single processor or parts of a program may be executed by different processors. Functions in the present embodiment may be performed by a plurality of divided programs, and in this case, an assembly of the plurality of programs may be defined as the program.

The functions in the present embodiment do not have to be performed only by processing by the processor, and may be performed by using various functions of a computer (a main processor, a memory, a sub processor, a peripheral circuit, software such as firmware, and a computer implemented by an interpreter or an emulator in some cases). For example, a manner in which the processor executes the program to provide instructions to other processors, peripheral circuits, and the like and finally those other processors, peripheral circuits, and the like perform the functions is also encompassed in a mode of carrying out the present embodiment.

A system obtained by integrating main device 100 and controller 200 may be applicable. A manner in which processing performed by a single processor in the present embodiment is performed as being allocated to a plurality of processors in cooperation is also encompassed herein as a modification.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. An information processing system comprising:
one or more processors; and
one or more memories having stored therein instructions that, when executed, cause the one or more processors to perform operations comprising
controlling drive of a vibration motor in accordance with vibration instructions from an application program,
determining whether a first condition is satisfied and whether a second condition is satisfied,
restricting vibration of the vibration motor when at least one of the first condition or the second condition is satisfied, and
providing a user with a notification of restriction of vibration of the vibration motor in a manner different between when the first condition is satisfied and when the second condition is satisfied.

2. The information processing system according to claim 1, wherein
the first condition comprises a condition about a temperature, and
the second condition comprises a condition about a remaining battery level.

3. The information processing system according to claim 1, wherein
the notification is provided when change from a state in which the first condition or the second condition is not satisfied to a state in which the first condition or the second condition is satisfied.

4. The information processing system according to claim 1, wherein
the notification is provided when change from a state in which the first condition or the second condition is not satisfied to a state in which the first condition or the second condition is satisfied, and
for the second condition, a second threshold value for determining that the second condition is not satisfied is higher than a first threshold value for determining that the second condition is satisfied.

5. The information processing system according to claim 1, wherein
when the first condition is satisfied, vibration of the vibration motor is restricted for a predetermined time period.

6. The information processing system according to claim 1, wherein
the notification is provided when the vibration instructions are provided from the application program after at least one of the first condition or the second condition is satisfied.

7. The information processing system according to claim 1, wherein
the notification comprises showing the notification including an image generated by the application program.

8. The information processing system according to claim 6, wherein
the notification is not further provided even when the application program provides further vibration instructions while restriction of vibration of the vibration motor continues.

9. The information processing system according to claim 8, wherein
after restriction of vibration of the vibration motor is released, when at least one of the first condition or the second condition is satisfied and vibration of the vibration motor is restricted again and then when the application program provides the vibration instructions, the notification is provided.

10. The information processing system according to claim 1, comprising:
a main device; and
a controller comprising the vibration motor, wherein
the controller is configured to make the determination as to whether the first condition is satisfied and whether the second condition is satisfied,
the controller is configured to periodically transmit a result of the determination to the main device, and
the main device is configured to provide the notification based on at least one of change from a state in which the first condition is not satisfied to a state in which the first condition is satisfied or change from a state in which the second condition is not satisfied to a state in which the second condition is satisfied, based on the result of the determination.

11. The information processing system according to claim 1, comprising:
a main device; and
a plurality of controllers each including the vibration motor, wherein
each of the plurality of controllers is configured to make the determination as to whether the first condition is satisfied and whether the second condition is satisfied,
each of the plurality of controllers is restricted based on a corresponding result of the determination,
the main device is configured to determine whether the notification is required for each controller, based on the result of the determination from each of the plurality of controllers, and
the notification includes identification information of a controller where vibration is restricted.

12. The information processing system according to claim 1, comprising a plurality of controllers each including the vibration motor, wherein
the determination as to whether the first condition is satisfied and whether the second condition is satisfied is made for each of the plurality of controllers,
each of the plurality of controllers is restricted based on a corresponding result of the determination,
the vibration instructions from the application program comprise identification information that designates a controller which is an output destination among the controllers,
the notification is provided when the application program provides the vibration instructions, with a controller where vibration is restricted being designated among the controllers, and
the notification includes identification information of the controller where vibration is restricted.

13. One or more non-transitory computer-readable media having stored therein a game program that, when executed, causes an information processing system to perform operations comprising:
controlling drive of a vibration motor in accordance with vibration instructions from an application program;
determining whether a first condition is satisfied and whether a second condition is satisfied;
restricting vibration of the vibration motor when at least one of the first condition or the second condition is satisfied; and
providing a user with a notification of restriction of vibration of the vibration motor in a manner different between when the first condition is satisfied and when the second condition is satisfied.

14. The one or more non-transitory computer-readable media according to claim 13, wherein
the first condition comprises a condition about a temperature, and
the second condition comprises a condition about a remaining battery level.

15. The one or more non-transitory computer-readable media according to claim 13, wherein
the notification is provided when change from a state in which the first condition or the second condition is not satisfied to a state in which the first condition or the second condition is satisfied.

16. The one or more non-transitory computer-readable media according to claim 13, wherein
the notification is provided when change from a state in which the first condition or the second condition is not satisfied to a state in which the first condition or the second condition is satisfied, and
for the second condition, a second threshold value for determining that the second condition is not satisfied is higher than a first threshold value for determining that the second condition is satisfied.

17. A computer-implemented method comprising:
driving a vibration motor in accordance with vibration instructions from an application program;
making determination as to whether a first condition is satisfied and whether a second condition is satisfied;
restricting vibration of the vibration motor when at least one of the first condition or the second condition is satisfied; and
providing a user with a notification of restriction of vibration of the vibration motor, together with a reason based on the determination.

18. The computer-implemented method according to claim 17, wherein
the first condition comprises a condition about a temperature, and
the second condition comprises a condition about a remaining battery level.

19. The computer-implemented method according to claim 17, wherein
the notification is provided when change from a state in which the first condition or the second condition is not satisfied to a state in which the first condition or the second condition is satisfied.

20. The computer-implemented method according to claim 17, wherein
the notification is provided when change from a state in which the first condition or the second condition is not satisfied to a state in which the first condition or the second condition is satisfied, and
for the second condition, a second threshold value for determining that the second condition is not satisfied is higher than a first threshold value for determining that the second condition is satisfied.
